(19) United States
(12) Patent Application Publication
(10) Pub. No.: US 2025/0209313 A1
(43) Pub. Date: Jun. 26, 2025

(54) METHOD AND SYSTEM FOR IMPLEMENTING ENCODER PROJECTION IN NEURAL NETWORKS

(71) Applicant: BrainChip, Inc., Laguna Hills, CA (US)

(72) Inventors: Olivier Jean-Marie Dominique COENEN, PhD, Encinitas, CA (US); Yan Ru PEI, Irvine, CA (US)

(21) Appl. No.: 18/991,246

(22) Filed: Dec. 20, 2024

Related U.S. Application Data
(60) Provisional application No. 63/614,220, filed on Dec. 22, 2023.

(51) Int. Cl. G06N 3/048; G06F 17/16

(52) U.S. Cl. CPC G06N 3/048; G06F 17/16

(57) ABSTRACT

Disclosed is a neural network system that includes a memory and a processor. The memory is configured to store a plurality of storage buffers corresponding to a current neural network layer, and implement a neural network that includes a plurality of neurons for the current neural network layer and a corresponding group among a plurality of groups of basis function values. The processor is configured to receive an input data sequence into the first plurality of storage buffers over a first time sequence and project the input data sequence on a corresponding basis function values by performing, for each connection of a corresponding neuron, a dot product of the first input data sequence within a corresponding storage buffer with the corresponding basis function values and thereby determine a corresponding potential value for the corresponding neurons. Thus, utilizing the corresponding potential values, the processor generates a plurality of encoded output responses.

### RELATED APPLICATIONS

This application claims the benefit of priority to U.S. Provisional Patent Application No. 63/614,220 entitled “A Method And System For Implementing Encoder Projection In Neural Networks” filed Dec. 22, 2023, the entire contents of which are hereby incorporated by reference for all purposes.

### TECHNICAL FIELD

The present disclosure generally relates to the field of neural networks (NNs). In particular, the present disclosure relates to a generative neural networks (NNs) for sequential data for generating content.

### BACKGROUND

Neural networks (NNs) are important elements of artificial intelligence (AI) technology. Artificial Neural Network (ANN), Convolutional Neural Network (CNN), and Recurrent Neural Network (RNN) are some of the common types of NNs.

Recently different methods have been explored to generate AI-based content using the aforementioned NNs. It is critical for some applications for a neural network to be able to generate content. The neural networks that are capable of generating the AI-based content are called generative models or generative networks. One of the commonly known generative networks is RNNs and the other commonly known generative networks are transformers. The RNNs were traditionally used to generate the content before the emergence of the transformers. Transformers and variants have been at the basis of the advances in generative models, particularly in the domain of large language models (LLMs).

For each of the above-discussed NN models including ANN, CNN, and RNN, the computation process is very often performed in the cloud for generating the content. However, in order to have a better user experience and privacy, and for various commercial reasons, an implementation of the computation process has started moving from the cloud to edge devices. In order to generate AI-based content, there are mainly two solutions available in the state of the art i.e., RNNs and transformers. However, RNNs are difficult to train because of the recurrence they take more time to train. Transformers generate content without having to make use of recurrence, which permits parallelized training. The transformers are capable of being trained efficiently in the cloud by leveraging Graphics Processing Unit (GPU) or Tensor Processing Unit (TPU) for parallel computation.

Further, with the increasing complexity of the NN models, there is a corresponding increase in the computational requirements required to execute highly complex NN models, for example, the transformer based models. Thus, a huge computational processing and a large memory are required for executing highly complex transformer based models.

Thus, there lies a need for a method and system to reduce the computational requirements of the above-discussed NN models while still meeting desired accuracy expectations, in order to facilitate more efficient content generation, particularly for the edge devices.

### SUMMARY

This summary is provided to introduce a selection of concepts in a simplified form that is further described below in the Detailed Description section. This summary is not intended to identify or exclude key features or essential features of the claimed subject matter, nor is it intended to be used as an aid in determining the scope of the claimed subject matter.

For generating content, the neurons of NN models, such as polynomial expansion in adaptive distributed event-based systems (PLEAIDES) models, perform a temporal convolution operation on input signals with the temporal kernels. In some aspects, the temporal kernels are represented as an expansion over a basis function with kernel coefficients Gᵢ. In some aspects, the kernel coefficients are trainable parameters of the neural network during learning. In some aspects, the kernel coefficients remain constant while generating content using convolutions during inference. Even though the recurrent mode of PLEIADES decomposes the convolution with a kernel onto a set of basis functions, the contribution from each may not be used individually, but summed together to provide a scalar value of the convolution. Such a scalar value has more limited power in generating signals than if a contribution, coefficient, from each basis could be used.

Some aspects include a neural network system that includes an input interface, a memory, and a processor. The input interface may be configured to receive sequential data that includes input data sequences. The memory may be configured to store a plurality of group of first basis function values, a first plurality of storage buffers corresponding to a current neural network layer, and implement a neural network that includes a first plurality of neurons for the current neural network layer, a corresponding group among the plurality of groups of the first basis function values may be associated with each connection of a corresponding neuron of the first plurality of neurons. In some embodiments, to perform a projection operation, the processor may be configured to allocate the first plurality of storage buffers to a first group of neurons among the first plurality of neurons. The processor may be further configured to receive a first input data sequence of the corresponding input data sequences into the first plurality of storage buffers allocated to the first group of neurons from corresponding input data sequences over a first time sequence. Further, the processor may be configured to project the first input data sequence on a corresponding basis function values among the corresponding group of the first basis function values by performing, for each connection of a corresponding neuron of the first group of neurons, a first dot product of the first input data sequence of the corresponding input data sequences within a corresponding storage buffer of first plurality of storage buffers with the corresponding basis function values, wherein the corresponding basis function values may be associated with a corresponding connection of the corresponding neuron of the first group of neurons. The processor may be further configured to determine a corresponding potential value for the corresponding neurons of the first group of neurons based on the performed first dot product. The processor may be further configured to generate a plurality of encoded output responses based on the determined corresponding potential values.

Some aspects include a neural network system that includes an input interface, a memory, and a processor. The input interface may be configured to receive sequential data that includes temporal data sequences. Further, the memory may be configured to implement a neural network and store a plurality of gain values, a first reference tensor to update a memory tensor. The neural network may be configured to perform a temporal projection using one or more temporal layers, a corresponding temporal layer of the one or more temporal layers includes a plurality of neurons. In some embodiments, for corresponding temporal layers of the one or more temporal layers, at least one processor may be configured to receive a first temporal data sequence of the temporal data sequences at a first time instance. Further, the at least one processor may be configured to generate a projected temporal input based on a projection of the first reference tensor on the first temporal data sequence. Further, the at least one processor may be configured to transform, for the first temporal data sequence, the memory tensor based on a matrix multiplication of a second reference tensor with the memory tensor and generate an updated memory tensor based on the transformed memory tensor and the projected temporal input. Further, the at least one processor may be configured to perform, for each connection associated with a corresponding neuron of a group of neurons among the plurality of neurons, a first element-wise multiplication of the updated memory tensor with the plurality of gain values. Further, the at least one processor may be configured to determine a corresponding potential value for the corresponding neurons based on the performed first element-wise multiplication. Further, the at least one processor may be configured to generate a plurality of encoded output responses based on the determined corresponding potential values.

Some aspects may further include a method for determining the corresponding potential value for the corresponding neurons that includes applying one or more activation functions on the corresponding result of the dot products, and determining the corresponding potential value for the corresponding neurons based on a result of the application of the one or more activation functions on the corresponding result of the dot products.

Further aspects provide methods for performing spatiotemporal data processing in a neural network including performing an (event-based) convolution or projection on a spatial, temporal, or spatiotemporal input signal with a plurality of independent component basis to generate projection (or convolution) coefficients associated with (one or more events in) the input signal, applying a cost function that enhances sparsity and independence in the projection (or convolution) coefficients, processing the projection (or convolution) coefficients through a nonlinearity function to generate transformed output projection (or convolution) coefficients, repeating the same process at possibly different temporal and/or spatial scales, then finish with that, or possibly, pursue by performing an operation (e.g., multiplication) of the transformed output projection coefficients with a basis set, defined by the plurality of independent component basis, reconstructing a processed signal using the outputs of the projection of the output coefficients on the plurality of independent component basis, and outputting the processed signal to an edge device. Some aspects may further include adjusting the independent component basis in buffer mode or a recurrent mode based on the projection coefficients and a cost function configured to enhance sparsity and independence in the projection coefficients. In some aspects, the convolution or projection on the spatial, temporal, or spatiotemporal input signal may be event-based, but in some aspects, the convolution or projection may not be event-based.

### BRIEF DESCRIPTION OF DRAWINGS

Non-limiting and non-exhaustive embodiments of the invention are described with reference to the following figures, in which reference numerals refer to like parts throughout the various views unless otherwise specified.

FIG. 1 illustrates an example system diagram of an apparatus configured to implement a neural network in accordance with some embodiments.

FIG. 2 illustrates another example system diagram of an apparatus configured to implement the neural network in accordance with some embodiments.

FIG. 3A illustrates a detailed system architecture of the apparatus configured to implement the neural network in accordance with some embodiments.

FIGS. 3B-3C illustrates temporal convolution operations leveraging an expansion over temporal basis in FIG. 3C and without in FIG. 3B, followed by a nonlinear operation.

FIG. 4A illustrates an overall method for encoder projection operations according to some embodiments.

FIG. 4B illustrates an example representation of the neural network including neural layers and a plurality of neurons therein along with allocated corresponding storage buffers and corresponding basis function values in accordance with some embodiments.

FIG. 4C illustrates another example representation of the neural network including a plurality of neural network layers and a plurality of neurons therein along with allocated corresponding storage buffers and corresponding basis function values in accordance with some embodiments.

FIG. 5 illustrates the operations to determine the output response of a single neuron for a single channel based on an encoder projection of input signals using a storage buffer in a buffer mode operation, in accordance with embodiment of the present disclosure.

FIG. 6 illustrates a detailed operation of shifting of the data in the storage buffer in neural network layers in a buffer mode operation according to some embodiments.

FIG. 7 illustrates a flow chart of a method 1050 performed by a processing system 300 including a neural processor 320 for performing encoder projection operation in the buffer mode using one or more neural network layers of the neural network 400 in accordance with some embodiments.

FIG. 8 illustrates an example representation of the neural network including a plurality of neural network layers and the plurality of neurons along with the working of the neural network in a recurrent mode, in accordance with some embodiments.

FIG. 9 illustrates an example scenario depicting a method of performing encoder projection at a corresponding neural network layer of the neural network in the recurrent mode in accordance with some embodiments.

FIG. 10 is a flow chart of a method performed by the neural processor for performing, in the recurrent mode, encoder projection, mid-layer processing, and decoding which generates content using one or more neural network layers of the neural network in accordance with some embodiments.

FIGS. 11A-11C illustrate example systems for performing decoder operations for signal generation at the corresponding decoder layer of the neural network in the buffer mode in accordance with some embodiments.

FIG. 12 illustrates an example scenario depicting a method of performing decoder operation for signal generation operation at the corresponding neural network layer of the neural network in the recurrent mode in accordance with some embodiments.

FIGS. 13 and 14 illustrate a future response prediction operation of neurons in the neural network according to some embodiments.

FIG. 15 illustrates an example scenario depicting a method of performing encoder operations for input signal analysis in a neural network in the recurrent mode in accordance with some embodiments.

FIGS. 16A-16E are process flow diagrams that illustrate a method of processing spaciotemporal data streams in accordance with some embodiments.

FIG. 17 is a component block diagram illustrating an example edge computing device in the form of a headset that is suitable for implementing some embodiments.

FIG. 18 is a component block diagram illustrating an example edge computing device in the form of a laptop that is suitable for implementing some embodiments.

FIG. 19 is a component diagram of a server suitable for implementing some embodiments.

The features and advantages of the present disclosure will become more apparent from the detailed description set forth below when taken in conjunction with the drawings, in which similar reference numbers identify corresponding elements throughout. In the drawings, similar reference numbers generally indicate identical, functionally similar, and/or structurally similar elements. Further, the drawings may show only those specific details that are pertinent to understanding the embodiments of the invention so as not to obscure the drawings with details that will be readily apparent to those of ordinary skill in the art having the benefit of the description herein.

### DETAILED DESCRIPTION

Detailed descriptions of various embodiments are presented herein, along with accompanying drawings that form an essential component of this disclosure. Said drawings serve to illustrate specific embodiments, thereby providing a more comprehensive understanding of the subject matter. However, the concepts of the present disclosure may be implemented in many different forms and should not be construed as limited to the embodiments set forth herein; rather, these embodiments are provided as part of a thorough and complete disclosure, to fully convey the scope of the concepts, techniques, and implementations of the present disclosure to those skilled in the art. Embodiments may be practiced as methods, systems, or devices. Accordingly, embodiments may take the form of a hardware implementation, an entire software implementation, or an implementation combining software and hardware aspects. The following detailed description is, therefore, not to be taken in a limiting sense.

References in the specification to “one embodiment,” “an embodiment,” “another embodiment,” or “some embodiment” means that a particular feature, structure, or characteristic described in connection with the embodiments is included in at least one example implementation or technique in accordance with the present disclosure. The appearances of the phrase “in an embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Embodiments of the present disclosure may be implemented in hardware, firmware, software, or any combination thereof. Embodiments of the present disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical, or other forms of propagated signals (e.g., carrier waves, infrared signals, digital signals, etc.), and others. Further, firmware, software, routines, and instructions may be described herein as performing certain actions. However, it should be appreciated that such descriptions are merely for convenience and that such actions result from computing devices, processors, controllers, or other devices executing the firmware, software, routines, instructions, etc.

As used herein the term “basis function” refers to a building block used in signal processing and neural networks to analyze and represent complex input signals, such as audio or images, in a simplified form. Each basis function captures a specific feature or pattern, allowing the signal processing system and network to decompose the input into meaningful components that can then be fed into artificial neurons.

As used herein, the term “convolution” refers to a mathematical operation that “mixes” two functions to produce a new function that shows how one function changes when it is combined with the other. Mathematically, convolution involves shifting one function, multiplying it by another, and then integrating (summing up) the result, providing a measure of their alignment or overlap over a specific interval.

As used herein, the term “projection” refers to the mathematical operation of mapping an input signal onto a set of basis functions to produce projection coefficients. This process involves evaluating how closely the input signal aligns with each basis function such as by calculating an inner product that measures the degree of similarity between the signal and the basis function. The result of this operation for each basis function may be a projection coefficient that represents the contribution of that particular basis function to the overall signal. Unlike convolution, which combines two functions to produce a third function reflecting their overlap across shifts, projection focuses on expressing the input signal as a weighted sum of the basis functions in which the weights are given by the projection coefficients.

In some embodiments, the convolution and projection operation may be related to each other in the following manner. If a kernel is the reflection of a basis function around its middle point (mirror reflection) then the convolution of the kernel is equivalent to the projection with its related basis function. Once discretized, both operations may be performed by a dot product.

To clarify, consider a finite kernel h(τ) defined between the values of τ: 0 and T and an input varying in time ƒ(t). The projection operation at time t+T involves summing or integrating ƒ(t+τ) h(τ) from values of τ: [0, T], such as at τ=0, ƒ(t) h(0) and at τ=T, ƒ(t+T) h(T). Equivalently, the projection operation at time t involves summing or integrating ƒ(t+τ−T) h(τ)=ƒ(t−T+τ) from values of τ: [0, T], such as at τ=0, ƒ(t−T) h(0) and at τ=T, ƒ(t) h(T). Thus, in this example, the projection is summing the dot product of the input and the kernel at different bin values that increase together.

A convolution with the same kernel is the sum or integral of ƒ(t−τ) h(τ) again from values of τ: [0, T], such as at τ=0, ƒ(t) h(0) and at τ=T, ƒ(t−T) h(T). In this case, the lowest bin of the kernel h(0) multiplies the current bin value of the input ƒ(t), and the highest bin of the kernel h(T) multiplies the oldest bin value of the input ƒ(t−T). This is the mirror image (reflection) of the result for the projection at τ=0, ƒ(t−T) h(0) and at τ=T, ƒ(t) h(T), where the lowest bin of the kernel h(0) multiplies the oldest bin value of the input ƒ(t−T), and the highest bin of the kernel h(T) multiplies the current bin value of the input ƒ(t).

Thus, if a basis function is the reflection of a kernel, then both the kernel convolution and projection with the basis function will give the same results. In this disclosure, anywhere a projection with a basis function occurs, it may be replaced by a convolution with a kernel being the mirror reflection of the basis function, and vice versa, without loss of generalization. One major difference between projections and kernels is that basis are typically considered as a set, an ensemble, often meant to span an entire space, whereas kernels are rarely considered as a set. Yet, as presented above, for every set of basis functions used for projection operations, a related set of kernels may be obtained through the mirror reflection of the basis function to form an equivalent set of kernels for convolution operations, spanning the very same space.

A major aspect of the disclosure is that projections onto an independent component basis of the input(s) with the goal of obtaining as independent and sparse projection coefficients is equivalent to obtaining sparse and independent convolution outputs from a set of convolution kernels that are constructed as the mirror image of the independent component basis used in the projections. As a consequence, any hardware capable of computing convolutions is directly capable of computing projections simply by mirroring the kernels without any other changes.

Before describing such embodiments in more detail, however, it is instructive to present an example environment in which embodiments of the present disclosure may be implemented.

Various embodiments include a neural network (NN), particularly related to a generative neural network that generates a plurality of output responses, using basis function values, in response to input sequential data (sometimes referred to herein as an input signal) including input data sequences. In some embodiments, the basis function values are trainable and capable of being modified dynamically to be in tune with the input sequential data.

In some embodiments, the neural network may correspond to a spatiotemporal neural network, spatial neural network, temporal neural network, or neural network processing other dimensions than temporal or spatial, such as light frequencies, light colors, light polarization, and physical spins. In a non-limiting example, the neural networks may include a plurality of temporal layers, spatial layers, spatiotemporal layers, or other dimensional layers that may combine dimensional, such as spatial and temporal, features of data for low-level and high-level features.

In some embodiments, the neural network may be configured to perform in parallel different channels, in which neurons have different values of parameters from channel to channel. In some embodiment, the outputs of these multiple channels are fully connected when projecting to a next layer.

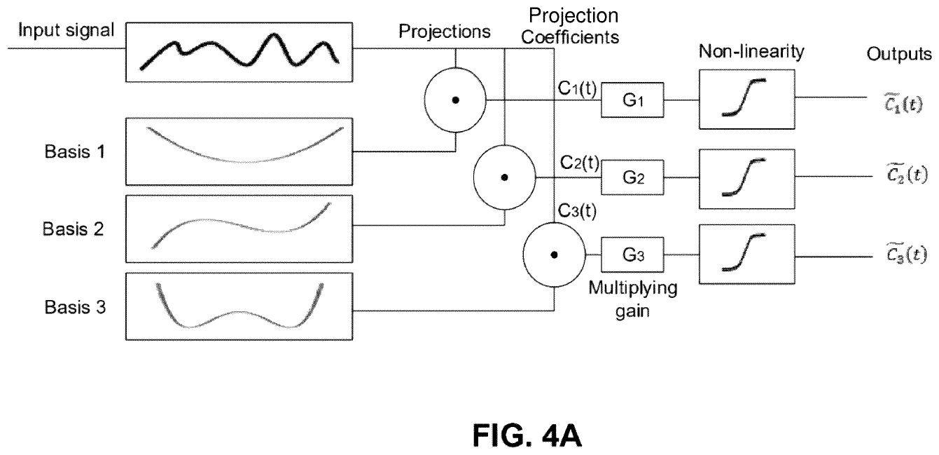

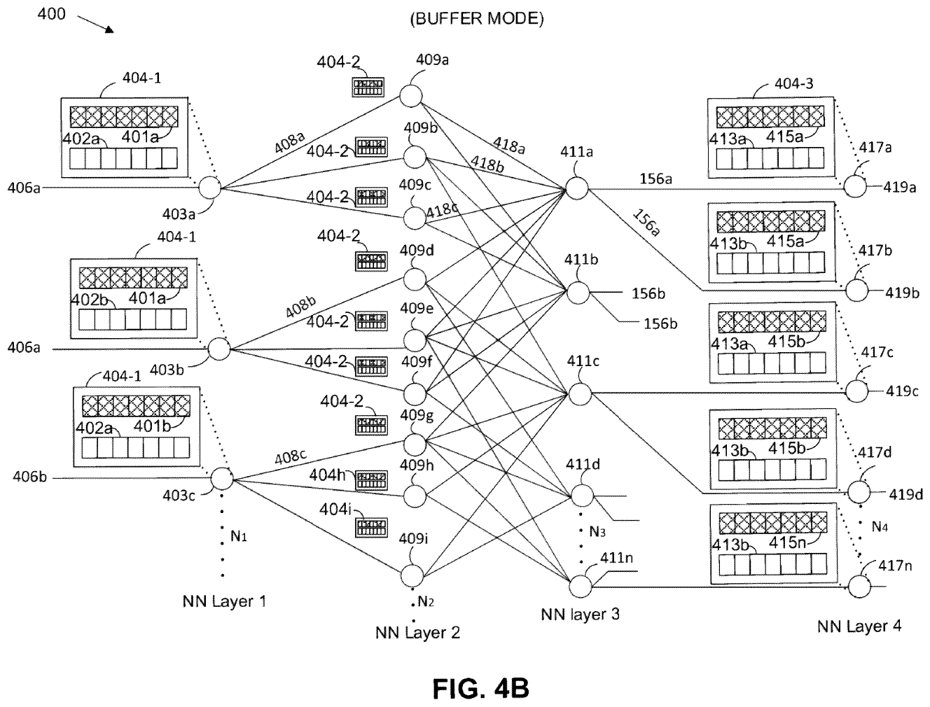

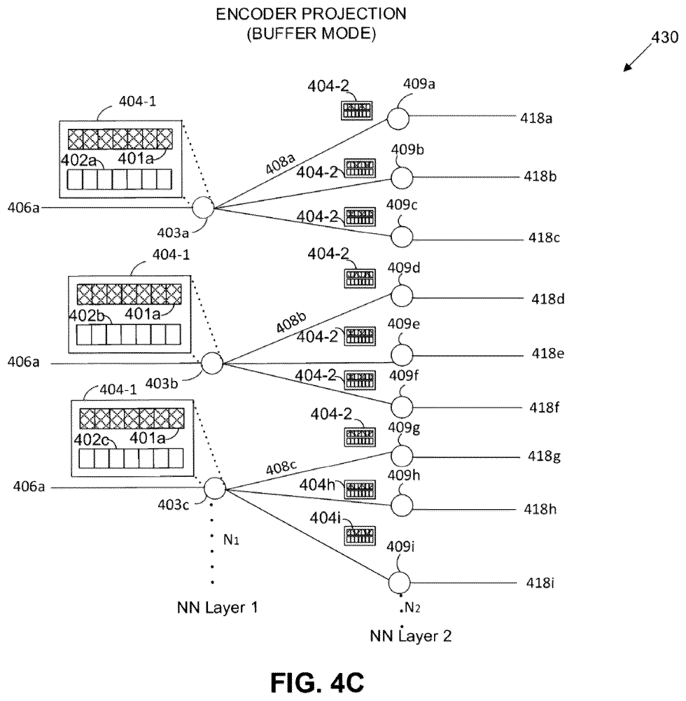

In some embodiments, the neural network may be configured to perform an encoder projection operation either in a buffer mode or in a recurrent mode. In some embodiments, the buffer mode operation is preferred during training and the recurrent mode operation is preferred during inference for generating processed content based on the input data stream or signal. The preferred operations in the buffer mode and the recurrent mode may be ascertained from the detailed operations of the buffer mode and the recurrent mode as described below with reference to FIGS. 4 to 14.

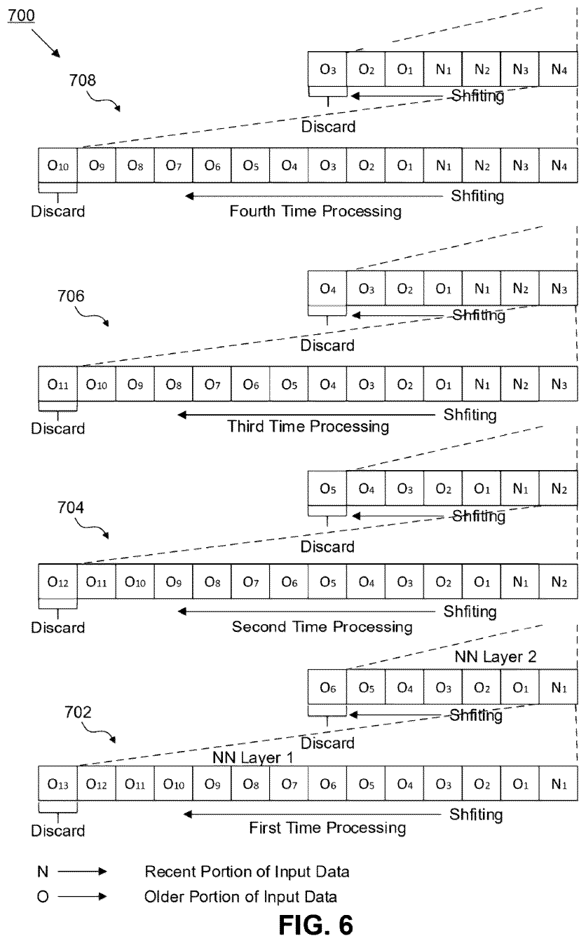

In some embodiments, the basis functions for each neural network layer are represented as a set of basis function values, such as orthogonal polynomials, where the gains associated with the projections of sequences onto the basis functions are trainable parameters of the neural network and are optimized during the training in the buffer mode. The basis functions are trainable in some embodiments, for example, by expressing the basis functions as expansions over set(s) of basis functions. Orthogonalization methods may be adapted to constraint trainable basis functions to remain orthogonal to each other during training if desired. In some embodiments, the basis functions are such that they are driven by the data and not limited to some a priori definition. This enables the encoder projection operation to process past and present inputs. This reduces the latency of the system to a large extent, since at any given layer, processing may begin immediately after the data corresponding to the current time instance is output by the previous layer. In addition, the representation of the basis function values as expansion over orthogonal polynomials allows the encoder projection operation to be easily converted between the buffered mode and the recurrent mode. This advantage may be ascertained from the detailed operation of the buffer mode with reference to FIG. 6 in the forthcoming paragraph.

In some embodiments, the basis function values correspond to a flipped value of a kernel that is used in the case that the processor is configured to perform a convolution operation instead of a projection operation. In some embodiments, the flipped value of the kernel represents a mirror inversion of kernel values along one or more dimensions.

In some embodiments, the input data sequence is projected onto the basis function either by performing a dot product or scalar multiplication of the input data sequences with the basis function values. In some embodiments, the input data sequence may be projected onto eigenfunctions yₙ(x). As an example, the normalized projection coefficients may be given by equation 1.

$${\tilde{a}}_{n} = \frac{{\int }_{a}^{b} f ( x ) r ( x ) {y}_{n} ( x ) dx}{{\int }_{a}^{b} r {( x ) [ {y}_{n} ( x ) ]}^{2} dx} \qquad ( 1 )$$

where ƒ(x) is the signal to be encoded, r(x) is a weight function that is used in the orthogonalization of the basis functions, or eigenfunctions.

The signal ƒ(x) may be approximated by a series expansion, where there is a finite number of eigenfunctions yₘ(x), the eigenfunctions are all orthogonal to each other with respect to r(x), and a function ƒ(x) may be approximated by a finite series given by equation 2.

$$f ( x ) = {\sum }_{m} {\tilde{a}}_{m} {y}_{m} ( x ) \qquad ( 2 )$$

In some embodiments, by ignoring the constant of integration, Ĩ, given by equation 3.

$$\tilde{I} = {\int }_{a}^{b} r {( x ) [ {y}_{n} ( x ) ]}^{2} dx \qquad ( 3 )$$

In a neural network, the projection coefficient aₙ is approximated by the integral of equation 4.

$${a}_{n} = {\int }_{a}^{b} f ( x ) r ( x ) {y}_{n} ( x ) dx \qquad ( 4 )$$

In some embodiments, the basis function values are approximated by a dot product between the input signal f(x) and a modified basis function r(x) yₙ(x) approximated by a binning procedure to form the basis values. In some embodiments, the basis function values are stored in a storage buffer of a memory.

In some embodiments, as the input signal changes with the value of x, which may be time t, ƒ(t), the window [a, b] also moves with time, such that the basis yₙ(t) also moves with it. Thus, at each time bin, a new value of aₙ(t) is computed. In some embodiments, aₙ(t) is the coefficient of the projection of the input signal onto the basis function r(t) yₙ(t)=yₙ(t), when r(t)=1. Accordingly, once aₙ(t) is discretized into bins, the coefficient aₙ(t) of the projection is given by the dot product between the binned input signal ƒ(t) and the binned basis yₙ(t). In some embodiments, the projection coefficient aₙ(t) is applicable for both the encoder projection operation in the buffer mode and in the recurrent mode.

In some embodiments, the projection coefficients are obtained by projecting the input signal ƒ(τ) onto the basis functions and, once binned, written as vectors over timebins, they are obtained by a dot product, given by equation 5.

$${a}_{n} ( t ) = {\int }_{t - Δ}^{t} f ( τ ) {y}_{n} ( τ ) d τ \to \vec{f} ( t ) \cdot {\vec{y}}_{n} ( t ) \qquad ( 5 )$$

To improve the projection operations, some embodiments may incorporate a cost function J(t) seeking to increase sparseness and independence (the sparse cost function) of the representation within a buffer computation or a recurrent process to modify the basis functions in a neural network or signal processing system. The sparse cost function J(t) may be applied to tune the coefficients of each basis function iteratively, enforcing sparsity and statistical independence among the coefficients. This sparse structure encourages each coefficient to activate when it identifies a distinct feature within the input, resulting in a probability distribution that is both sparse and non-Gaussian. By penalizing dependencies and emphasizing sparsity, the J(t) cost function ensures that each basis function captures unique information, optimizing the representation and improving computational efficiency. This is particularly advantageous in an event-driven or Akida®-inspired architecture, where the sparse and independent structure of the coefficients directly enhances event-based efficiency by reducing redundant or unnecessary processing. Akida® is a type of neuromorphic computing framework developed by BrainChip Holdings Ltd., designed to mimic the way the human brain processes information using spiking neural networks (SNNs) and event-based neural networks (ENNs).

In various embodiments, the cost function may include different terms, one of which may be the product, but this is not exclusive. In some embodiments, the cost function is used in training to adapt parameters. Alternatively, the cost function may be used to generate a feedback that can direct the network activity to improve to be closer to optimizing the cost function. The cost function may include costs to provide sparse activations, which may be factorial code, that may result in activations that are more independent from each other than before application of the cost function. The cost function may have different “terms,” one of which may be for encouraging sparsity. Other terms may be for reducing some output errors, which may be typically supervised. Other terms may be unsupervised for fulfilling different constraints.

Some embodiments may further enhance data representations by constructing multiple independent basis at different scales, resolutions, or localized regions within the data. Multiscale projections may involve the equivalent of evaluating Independent Component Analysis (ICA) at each scale. ICA is a computational technique used to separate a multivariate signal into additive, independent components. ICA is commonly applied in signal processing and data analysis, particularly where mixed signals need to be decomposed into their underlying sources. In some embodiments, ICA enable processes to isolate independent features or components that might vary across scales or localized areas, which may enhance the accuracy of feature recognition or signal decomposition at each level of signal processing stages or neural network processing.

This multiscale approach leverages the realization that independent components may vary depending on the scale of analysis. For instance, in vision applications, fine-scale features, such as edges, may act as independent components. Edges themselves carry unique information, as they represent sharp transitions in the visual field, which are often important in identifying shapes and contours. At a larger scale, these edges may combine to form more complex features or objects, such as a wheel, which is also an independent component but at a different level of abstraction. A wheel, when detached from a vehicle, may independently exhibit specific characteristics, such as rolling motion. At an even higher scale, multiple wheels positioned in a specific configuration may collectively represent a vehicle, which functions as an independent entity with unique behavior.

This hierarchical construction of independent components at different scales may be achieved in the buffer mode or recurrent mode through a recursive application of basis modification driven by the J(t) cost function to improve sparsity and independence. Each scale is represented by a set of independent component basis functions that are modified iteratively to adapt to the features at that particular level of abstraction. Through matrix multiplications, scaling, and nonlinear transformations, the system refines each basis function to become sparse and independent at its respective scale. This process ensures that at each level, the basis functions are tailored to capture the significant features, whether they are small-scale edges or large-scale objects. The inclusion of techniques such as expressing nonlinearity through Legendre polynomial expansions further enhances the adaptability of each basis function, allowing the system to maximize information transfer by tuning the nonlinearity to the statistical properties of the input signals.

By maximizing mutual information through an optimized nonlinearity that matches the distribution of projection coefficients Cᵢ(t)={C₁(t), C₂(t), C₃(t), . . . } the neural network system may achieve a uniform output probability distribution that is particularly beneficial for quantization. The independence and sparsity of coefficients ensure that each feature extracted from the neuron input can be represented uniquely, with minimal redundancy, leading to higher fidelity in information encoding. In an encoder architecture, this enhanced representation translates to improved efficiency in data compression and signal fidelity, as only the most important features are encoded.

In some embodiments, the coefficients may be tuned using Slow Feature Analysis, which is a technique used in neural networks and machine learning to extract features that change slowly over time. Slow Feature Analysis helps to identify and tune features that are temporally stable or evolve gradually, as opposed to rapidly fluctuating features. This may be useful for tuning coefficients in the neural network model because the analysis enhances the temporal coherence of the extracted features. By applying Slow Feature Analysis, the model may tune the coefficients of each basis function or independent component to favor stability over time, which may help in further separating and stabilizing the independent components, leading to a more reliable representation.

By constructing multiple independent basis at different scales, the neural network system captures hierarchical features within complex inputs, such as audio, video, or image data, enabling a deeper understanding and more efficient processing of the input signal. The application of the sparse cost function J(t) ensures that each basis function is sparse and independent, enhancing computational efficiency and supporting event-driven processing models like Akida®, where energy efficiency and low latency are important. The multiscale approach allows for a layered decomposition of features, providing the neural network system with a robust framework for capturing information from simple components like edges to complex objects like vehicles. This hierarchical, event-driven, and information-optimized architecture is ideal for applications in real-time signal processing, autonomous systems, and resource-constrained environments, delivering enhanced performance, adaptability, and efficiency.

To maximize the mutual information, that is the entropy in the case of no (random) noise, the nonlinearity may be made to match the probability distribution of the Cᵢ(t) (projection coefficients). The probability distribution of the output will then be as uniform as possible, facilitating quantization. This requires the coefficients to be independent, which may be accomplished using a cost function J(t). By adjusting the nonlinearity in the neural network system to align with the probability distribution of Cᵢ(t), the output distribution may be made more uniform. A uniform probability distribution in this context allows for more efficient quantization, as each possible output value would occur with similar likelihood, minimizing information loss during quantization. This approach is advantageous in applications where precise digital encoding of output values is required, such as in data compression or transmission. To achieve such uniformity in the output distribution, it may be necessary for the projection coefficients to be statistically independent. Independence of coefficients ensures that each coefficient captures unique information, avoiding redundancy and enhancing the overall entropy of the coefficients. To enforce this independence, a cost function J(t) may be applied, which penalizes dependency among the coefficients and encourages a distribution closer to the desired uniform state. This cost function operates as a regularization mechanism, refining the coefficients iteratively to achieve an optimized balance of high entropy, independence, and uniform distribution, enhancing the robustness and efficiency of the neural network system in handling complex inputs.

For adaptation of the nonlinearity, nonlinearity may be expressed as an expansion of basis functions, like Legendre polynomials. In some embodiments, the nonlinearity applied to the projection coefficients Cᵢ(t) may be dynamically adapted by expressing it as an expansion of basis functions, such as Legendre polynomials. Using an expansion of basis functions allows for a flexible and precise representation of the nonlinearity, as each basis function within the expansion may be weighted and adjusted independently to achieve the desired response. Legendre polynomials are useful in this context because they form an orthogonal set of functions over a defined interval, meaning each polynomial in the sequence captures unique information without overlapping with others. By representing the nonlinearity in terms of Legendre polynomials, the neural network system may achieve a finely tuned response that adapts to the probability distribution or other characteristics of the coefficients. This approach enhances the adaptability and performance of the nonlinearity by allowing it to be modified incrementally through changes in the weights associated with each polynomial in the expansion, leading to an optimized output that better matches the neural network system's requirements for feature extraction or signal representation.

The approach of adapting the nonlinearity by expressing it as an expansion of basis functions, such as Legendre polynomials, presents an improvement over traditional neural network activation functions and traditional ICA algorithms. By tailoring the nonlinearity to match the characteristics of the input signals, the neural network may achieve a more customized and efficient transformation of data, particularly in applications like encoding. Legendre polynomials, as a series of orthogonal functions, for example, allow for a flexible and highly adaptable representation of the nonlinearity, where each polynomial term contributes independently to the overall shape of the function. This adaptability enables the nonlinearity to be specifically tuned to the statistical properties of the input signals, rather than relying on a fixed or generic nonlinear transformation.

In an encoder architecture, maximizing information transfer is important for achieving high-quality data representation with minimal loss. By constructing a nonlinearity that is specifically adapted to the input signals, the neural network system improves the encoding process, capturing more information in a compact and efficient form. This tailored nonlinearity enhances the neural network system's ability to separate and encode distinct features of the input, resulting in a richer, more informative signal representation. The use of basis functions like Legendre polynomials enables fine-grained adjustments to the nonlinearity, allowing the neural network system to respond dynamically to changes in the input signal's distribution or other characteristics. This results in improved fidelity in information transfer, supporting applications that require high-efficiency data encoding, such as compression, data transmission, and neural network-based sensory processing. By increasing the nonlinearity through this novel adaptation, some embodiments provide a more powerful and flexible method for maximizing data efficiency, particularly in scenarios where accurate and dense encoding of information is important.

The tuning of the coefficients of the temporal basis functions through the application of a sparse cost function J(t) yields several important advantages. By enforcing sparsity and independence among the coefficients, this application of the cost function encourages each coefficient to be activated selectively only when the corresponding basis function captures a distinct and meaningful feature of the input signal. This sparsity results in a representation where most coefficients are zero or near-zero for a given input, with only a few active coefficients carrying significant information. Such a sparse and independent probability distribution minimizes redundancy across coefficients, allowing each one to contribute unique information to the signal representation. This structure optimizes the efficiency of data processing, reducing unnecessary computations and enhancing the neural network system's overall performance.

The concept of “improving the Akida® event-based efficiency” refers to enhancing the efficiency of neuromorphic processing in event-based systems like Akida®, which is designed for real-time processing of sensory data. In event-based systems, rather than processing data at fixed time intervals, computations are triggered by specific “events” in the input—such as significant changes in a sensory signal. By creating a sparse set of coefficients with minimal interdependence, the neural network system ensures that only the most relevant events are processed, reducing the number of unnecessary or redundant computations. This event-based efficiency may be useful in neuromorphic applications, where power efficiency and low-latency responses are important. Through the tuning of coefficients with the sparse cost function J(t), some embodiments effectively reduce the computational load and enhance response times, allowing for faster, more energy-efficient operation in applications such as real-time monitoring, sensory processing, and other event-driven tasks. This not only makes the neural network system more efficient but also extends its applicability to edge computing and mobile applications, where processing power and energy resources are often constrained.

Various embodiments of the present disclosure will be described below in detail with reference to the accompanying drawings.

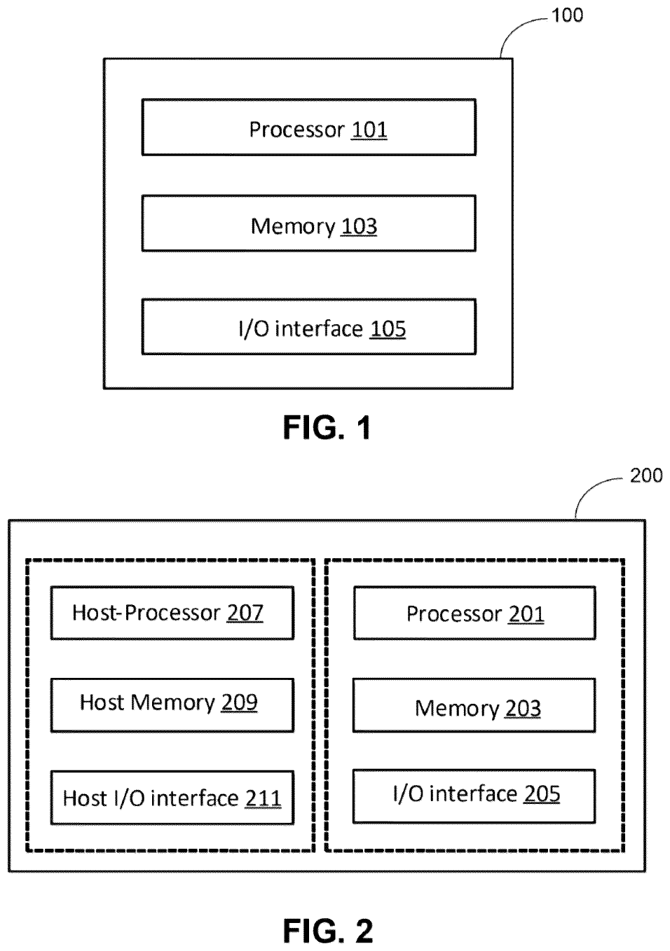

FIG. 1 illustrates an example system diagram of an apparatus configured to implement a neural network, in accordance with some embodiments. FIG. 1 depicts a system 100 to implement a spatiotemporal neural network. The system 100 includes a processor 101, a memory 103, and an input/output (I/O) interface 105.

The processor 101 may be a single processing unit or several units, all of which could include multiple computing units. The processor 101 is configured to fetch and execute computer-readable instructions and data stored in the memory 103. The processor 101 may receive computer-readable program instructions from the memory 103 and execute these instructions, thereby performing one or more processes defined by the system 100. The processor 101 may include any processing hardware, software, or combination of hardware and software utilized by a computing device that carries out the computer-readable program instructions by performing arithmetic, logical, and/or input/output operations. Examples of the processor 101 include but are not limited to an arithmetic logic unit, which performs arithmetic and logical operations, a control unit, which extracts, decodes, and executes instructions from a memory, and an array unit, which utilizes multiple parallel computing elements.

The memory 103 may include a tangible device that retains and stores computer-readable program instructions, as provided by the system 100, for use by the processor 101. The memory 103 may include computer system readable media in the form of volatile memory, such as random-access memory, cache memory, and/or a storage system. The memory 103 may be, for example, dynamic random-access memory (DRAM), a phase change memory (PCM), or a combination of the DRAM and PCM. The memory 103 may also include any non-transitory computer-readable medium known in the art including, for example, volatile memory, such as static random-access memory (SRAM), and/or non-volatile memory, such as read-only memory (ROM), erasable programmable ROM, flash memories, etc.

The I/O interface 105 includes a plurality of communication interfaces that may include at least one of a local bus interface, a Universal Serial Bus (USB) interface, an Ethernet interface, a Controller Area Network (CAN) bus interface, a serial interface using a Universal Asynchronous Receiver-Transmitter (UART), a Peripheral Component Interconnect Express (PCIe) interface, or a Joint Test Action Group (JTAG) interface. Each of these buses may be a network on a chip (NoC) bus. According to some embodiments, the I/O interface may further include sensor interfaces that may include one or more interfaces for pixel data, audio data, analog data, and digital data. Sensor interfaces may also include an AER interface for DVS pixel data.

FIG. 2 illustrates another example system diagram of an apparatus configured to implement the neural network, in accordance with some embodiments. FIG. 2 depicts a system 200 to implement the spatiotemporal neural network. The system 200 includes a processor 201, a memory 203, an I/O interface 205, Host-Processor 207, a Host memory 209, and a Host I/O interface 211. The functionalities, operations, and examples associated with the processor 201, memory 203, and I/O interface 205 of the system 200 are similar to that of the processor 101, memory 103, and I/O interface 105 of the system 100 of FIG. 1. Therefore, a description of the same is omitted herein for the sake of brevity and ease of explanation of the various embodiments.

The host-processor 207 may be a general-purpose processor, such as, for example, a state machine, a high-throughput MIC processor, a network or communication processor, a compression engine, a graphics processor, a general-purpose computing graphics processing unit (GPGPU), an embedded processor, or the like. The processor 201 may be a special purpose processor that communicates/receives instructions from the host processor 207. The processor 201 may recognize the host-processor instructions as being of a type that should be executed by the host-processor 207. Accordingly, the processor 201 may issue the host-processor instructions (or control signals representing host-processor instructions) on a host-processor bus or other interconnect, to the host-processor 207.

The host memory 209 may include any type or combination of volatile and/or non-volatile memory. Examples of volatile memory include various types of random-access memory (RAM), such as dynamic random access memory (DRAM), synchronous dynamic random-access memory (SDRAM), and static random access memory (SRAM), among other examples. Examples of non-volatile memory include disk-based storage mediums (e.g., magnetic and/or optical storage mediums), solid-state storage (e.g., any form of persistent flash memory, including planar or three dimensional (3D) NAND flash memory or NOR flash memory), a 3D Crosspoint memory, electrically erasable programmable read-only memory (EEPROM), and/or other types of non-volatile random-access memories (RAM), among other examples. Host memory 209 may be used, for example, to store information for the host-processor 207 during the execution of instructions and/or data.

The host I/O interface 211 corresponds to a communication interface that may be any of a variety of communication interfaces, such as a wireless communication interface, a serial interface, a small computer system (SCSI) interface, an Integrated Drive Electronics (IDE) interface, etc. Each communication interface may include a hardware present in each host and a peripheral I/O that operates in accordance with a communication protocol (which may be implemented, for example, by computer-readable program instructions stored in the host memory 209) suitable for this type of communication interface, as will be apparent to one skilled in the art.

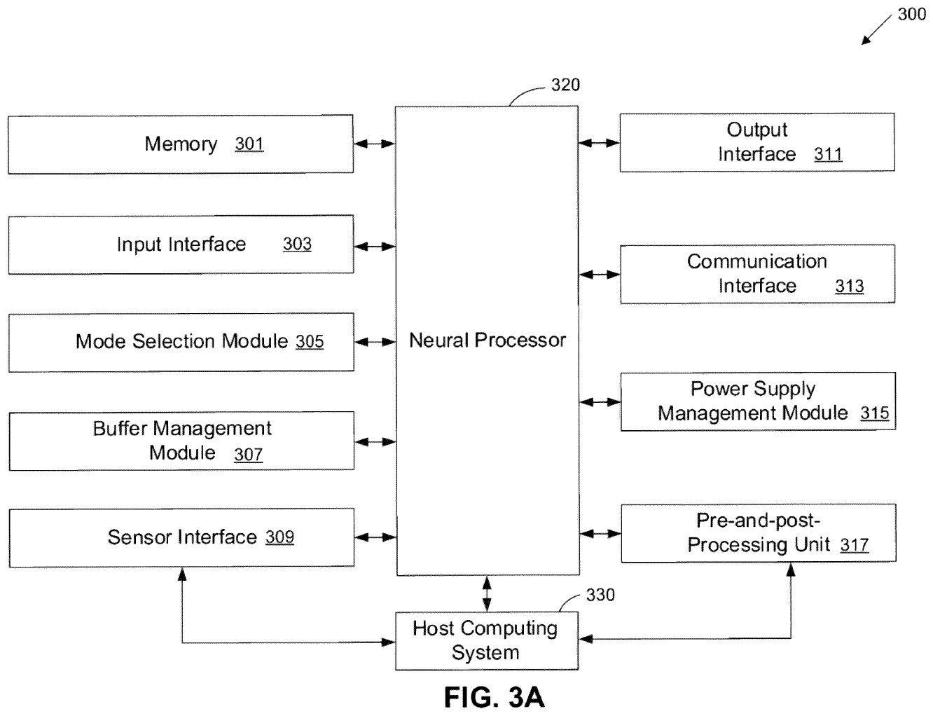

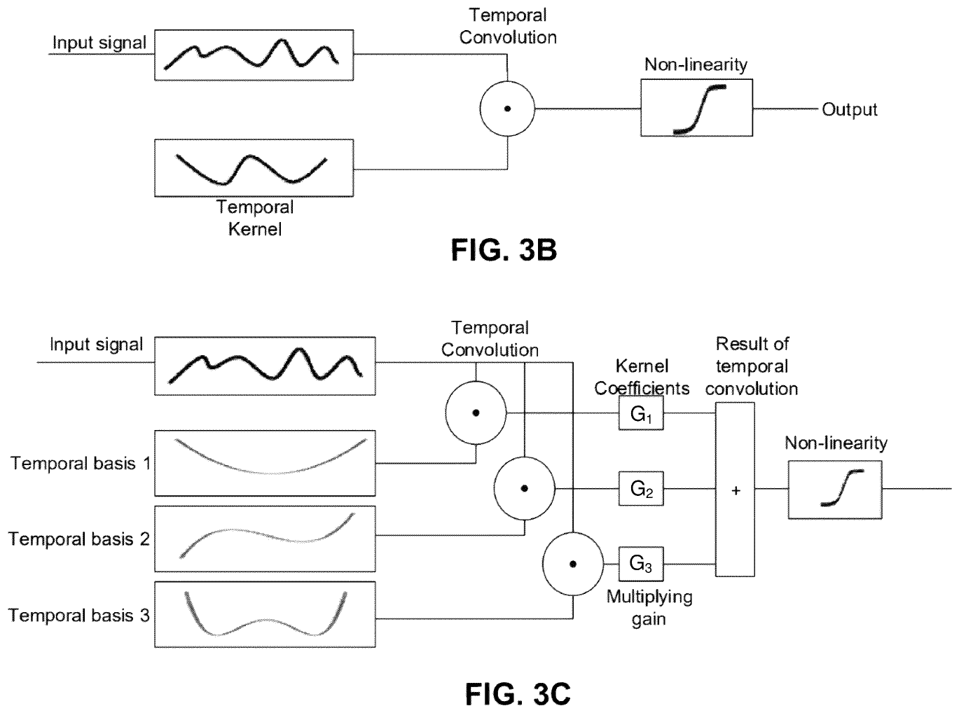

FIG. 3A illustrates a detailed system architecture of the apparatus configured to implement the neural network, in accordance with some embodiments. FIG. 3 depicts a system 300 to implement the NN. The system 300 includes a memory 301, an input interface 303, a mode selection module 305, a buffer management module 307, a sensor interface 309, an output interface 311, a communication interface 313, a power supply management module 315, a pre-and-post-processing unit 317, a neural processor 320, and a host computing system 330. The host computing system 330 may include the host-processor 207, host memory 209, and host I/O interface 211. The functionalities, operations, and examples associated with the components of the host computing system 330 are the same as that of the host-processor 207, host memory 209, and host I/O interface 211 of the system 200. Therefore, a description of the same is omitted herein for the sake of brevity and ease of explanation of the various embodiments.

The neural processor 320 may correspond to a neural processing unit (NPU). The (NPU) is a specialized circuit that implements all the necessary control and arithmetic logic necessary to execute machine learning algorithms, typically by operating on models such as artificial neural networks (ANNs) and spiking neural networks (SNNs). NPUs sometimes go by similar names such as a tensor processing unit (TPU), neural network processor (NNP), and intelligence processing unit (IPU) as well as vision processing unit (VPU) and graph processing unit (GPU). According to some embodiments, the NPUs may be a part of a large SoC, a plurality of NPUs may be instantiated on a single chip, or they may be a part of a dedicated neural-network accelerator. The neural processor 320 may also correspond to a fully connected neural processor in which processing cores are connected to inputs by the fully connected topology. Further, in some embodiments, the processor 101, 201, and the neural processor 320 may be an integrated chip, for example, a neuromorphic chip.

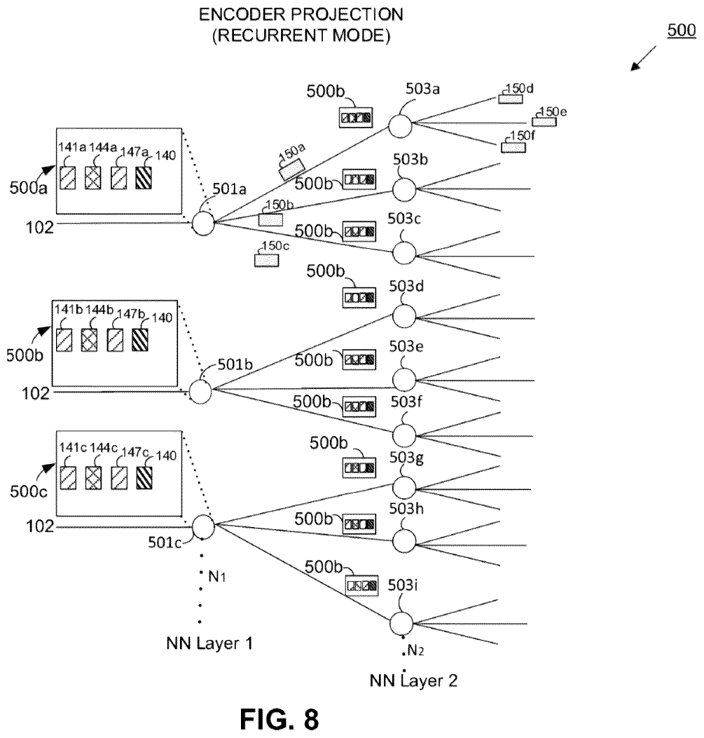

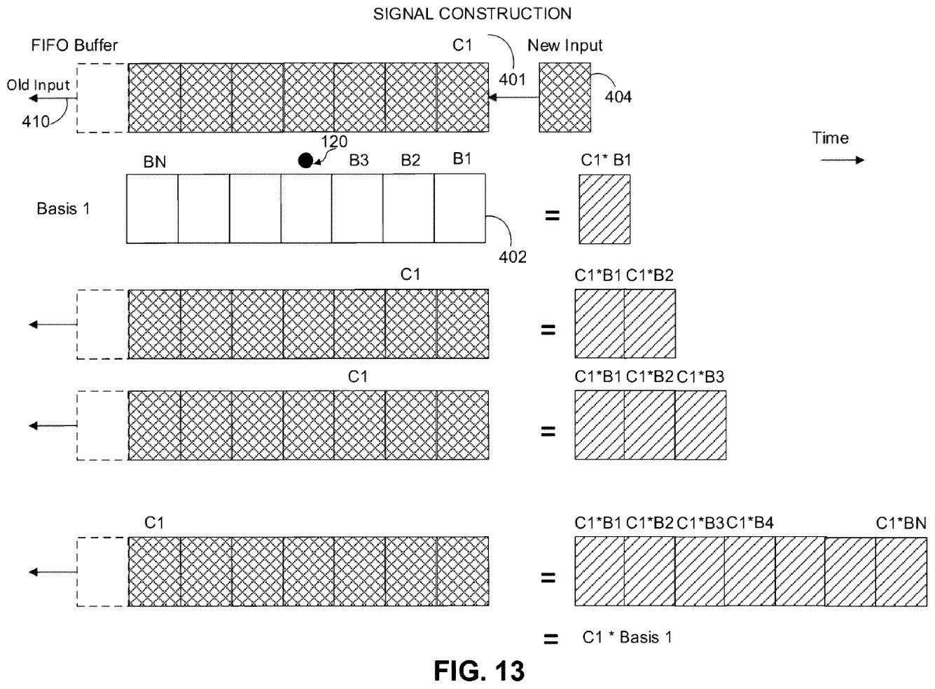

Also, examples of the memory 301 coupled to the neural processor 320 are the same as that of the memory examples described above with reference to the memory of FIG. 1 and FIG. 2. The memory 301 may be configured to implement the neural network that includes a plurality of neurons at each of the neural network layers (as described in the forthcoming paragraph with reference to FIGS. 4 and 13). In some embodiments, in the buffer mode, the memory 301 may be configured to store a plurality of groups of basis function values and a plurality of storage buffers corresponding to each of the neural network layers of the neural network. In some embodiments, each of the storage buffers may share the same basis function values for each neuron of a corresponding temporal convolution layer. The basis function values are associated with each connection of a corresponding neuron among the plurality of neurons of the respective neural network layers. A detailed explanation of the implementation of the NN within the memory 301 in the buffer mode is described below in detail with reference to FIGS. 4A, 4B, and 4C. Further, a detailed description of the implementation of the neural network within the memory 301 in the recurrent mode will be described below in forthcoming paragraphs with reference to FIGS. 8-10.

In some embodiments, each of the neurons among the plurality of the neurons of one neural network layer is connected with one or more neurons of the next neural network layer using neural connections each having specific connection parameters. A detailed explanation of the neural connections of the neurons and the associated connection parameters is described below in the forthcoming paragraphs with reference to FIGS. 4B and 4C.

The input interface 303 is configured to receive sequential data as input. In some embodiments, the sequential data may include one or more temporal data sequences, spatial data sequences, or spatiotemporal data sequences. According to a non-limiting example, the sequential data may include single or multi-channel tensor data received from sensors or electronic devices and the like.

The output interface 311 may include any number and/or combination of currently available and/or future-developed electronic components, semiconductor devices, and/or logic elements capable of receiving input data from one or more input devices and/or communicating output data to one or more output devices. According to some embodiments, a user of the system 300 may provide a neural network model and/or input data using one or more input devices wirelessly coupled and/or tethered to the output interface 311. The output interface 311 may also include a display interface, an audio interface, an actuator sensor interface, and the like.

The sensor interface 309 may correspond to a plurality of sensors including, but not limited to, an imaging sensor, a microphone, a motion sensor, a gyro sensor, a magnetometer, a temperature sensor, a humidity sensor, an accelerometer sensor, a spectrometric sensor, etc. The sensor interface 309 may also include at least one gyroscope sensor, a location sensor, a gesture recognition sensor, and/or a sensor for the detection of physiological parameters associated with the user of the system 300.

The communication interface 313 may include a single, local network, a large network, or a plurality of small or large networks interconnected together. The communication interface 313 may also include any type or number of local area networks (LANs) broadband networks, wide area networks (WANs), and a Long-Range Wide Area Network, etc. Further, the communication interface 313 may incorporate one or more LANs, and wireless portions and may incorporate one or more various protocols and architectures such as TCP/IP, Ethernet, etc. The communication interface 313 may also include a network interface to communicate via offline and online wireless communication with networks, such as the Internet, an Intranet, and/or a wireless network, such as a cellular telephone network, a wireless local area network (WLAN), personal area network, and/or a metropolitan area network (MAN). Wireless communication may use any of a plurality of communication standards, protocols, and technologies, such as LTE, 5G, beyond 5G networks, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VoIP), Wi-MAX, Internet-of-Things (IoT) technology, Machine-Type-Communication (MTC) technology, a protocol for email, instant messaging, and/or Short Message Service (SMS).

The pre-and-post-processing unit 317 may be configured to perform several tasks, such as but not limited to reshaping/resizing of data, conversion of data type, formatting, quantizing, image classification, object detection, etc. whilst maintaining the same spatiotemporal neural network architecture.

The mode selection module 305 may be configured to select one of the buffer mode or the recurrent mode to perform encoder projection operations at one or more neural network layers of the neural network implemented in the memory 301. A detailed explanation of the encoder projection operations in the buffer mode in an encoder is described below in the forthcoming paragraphs with reference to FIGS. 4 through 7. Further, a detailed explanation of the encoder projection operations in the recurrent mode is described below in the forthcoming paragraphs with reference to FIGS. 8 through 10.

The buffer management module 307 may be configured to manage the storage buffer that is allocated to a plurality of groups of neurons at one or more neural network layers of the neural network. A detailed explanation of the configuration of a neural network with respect to the storage buffer is described below in the forthcoming paragraphs with reference to FIGS. 4 through 7.

The power supply management module 315 may be configured to supply power to the various modules of the system 300.

Now, for generating an output response, the neurons of the neural network perform a temporal convolution operation on the input signal by performing temporal convolution of the input signal with the temporal kernels. In particular, the temporal kernels are represented by a set of basis functions. An example illustration of the temporal convolution operation in the neural network is shown in FIG. 3A and FIG. 3B. According to the temporal convolution operation, the coefficients a(t) that are propagated through the neural network corresponds to scalar values of the temporal convolution of the input ƒ(t) with a temporal kernel h(t). Accordingly, the convolution may be represented as the convolution of the input signal ƒ(τ) with the temporal kernel h(t−τ) and may be given by below shown equation 6:

$$a ( t ) = {\int }_{t - Δ}^{t} f ( τ ) h ( t - τ ) d τ \to {\sum }_{n} {G}_{n} {\int }_{t - Δ}^{t} f ( τ ) {y}_{n} ( t - τ ) d τ = {\sum }_{n} {G}_{n} {q}_{n} ( t ) \qquad ( 6 )$$

where h(t)=ΣₙGₙyₙ(t), and where the convolution with each basis function is given by equation 7:

$${q}_{n} ( t ) = {\int }_{t - Δ}^{t} f ( τ ) {y}_{n} ( t - τ ) \to \vec{f} ( t ) \cdot {\vec{y}}_{n} ( t ) \qquad ( 7 )$$

where [symbol] ₙ(t) is the mirror reflected version of yₙ(t−τ) over timebins covering the time period Δ.

In view of the abovementioned scenario with respect to the temporal convolution operation, once binned, involves performing a dot product between ƒ(τ) and h(t−τ), or with its representation using [symbol] (t)· [symbol] ₙ(t), for some time interval, or equivalently a certain number of timebins.

Referring to FIG. 3B, the temporal convolution operation is followed by a nonlinearity function at the output in the buffer mode. A similar computation is illustrated in FIG. 3C in which the temporal convolution is distributed over the basis functions since the temporal kernel is represented as an expansion over a basis function with coefficients Ci. The kernel coefficients are typically parameters of the network trained during learning. Thus, the kernel coefficients are constants according to the temporal convolution operation during inference. Although the basis function itself could be changed over time through learning, however for typical implementations the basis functions are kept fixed. Therefore, for each temporal convolution, the output is a scalar since all components over the basis are multiplied by the kernel coefficients and summed together. Accordingly, the way of performing convolution operations discussed in the paragraphs above allows the neural network to only generate a single output response, which is not very efficient for critical applications where content generation is required.

FIG. 4A illustrates an overall method for encoder projection operations according to some embodiments. In some embodiments, the encoder projection operations may be implemented in system 300. In a non-limiting example, the system 300 may include an encoder network, and a decoder network or a generator network. In some embodiments, the input signal is projected onto each basis function values of a set of basis functions in each neural network layer to generate corresponding projection coefficients. In a non-limiting example, three sets of basis functions are considered for the sake of brevity. However, the number of basis functions may be more than three and depends on the required application. Accordingly, when the input signal is projected onto the three basis function values derived from corresponding basis functions by performing a dot product of the input signal with each of the basis function values, three corresponding projection coefficients are generated, that is to say, Cᵢ(t)={C₁(t), C₂(t), C₃(t), . . . } are generated respectively. The generated projection coefficients are then multiplied by a corresponding multiplying kernel gain factor Gᵢ(t)={G₁(t), G₂(t), G₃(t), . . . }. Further, each of the corresponding resultant outputs is then passed through a corresponding non-linear activation function. Accordingly, for the encoder projection operations in the buffer mode, a plurality of encoded output responses are generated based on the performed dot product. In a non-limiting example, the plurality of output responses is shown as \tilde{C}ᵢ(t)={\tilde{C}₁(t), \tilde{C}₂(t), \tilde{C}₃(t), . . . }. Accordingly, the activity within the neural network represents the projection coefficients, or a nonlinear transformation of the projection coefficients. Thus, the projection coefficients are not constants but depend on time, even during the inference operations. Further, contrary to the temporal convolution operation that is performed in FIG. 3A and FIG. 3B, the convolution operation is replaced by a projection operation, thereby outputting a vector output rather than a scalar output.

In some embodiments, instead of performing a projection, the neural network may use the same basis as the neural network used for the convolution, but with the flipped temporal kernel value. Thus, the projection is a component-wise convolution with flipped basis function values.

According to an embodiment of the disclosure, FIG. 4B illustrates an example representation of the neural network 400, including neural layers and a plurality of neurons therein along with allocated corresponding storage buffers and corresponding basis function values, in accordance with some embodiments. FIG. 4B illustrates a neural network 400 for performing encoder projection operation in the buffer mode. For the sake of brevity of the present disclosure, the encoder projection operation using storage buffers is described with reference to four neural network layers, for example, NN layer 1, NN layer 2, NN layer 3, and NN layer 4.

According to an embodiment of the present disclosure, the neural network 400 includes a plurality of neural network layers. As explained in the above paragraphs, the neural network layers may correspond to the temporal layer, the spatial layer, or the spatiotemporal layer. In some embodiments, the arrangement of the neural network layers may be in any sequence and is not intended to limit the scope of the embodiments of the present disclosure. For example, the spatial layer may be arranged before or after any of the temporal layers 1, 2, or N. Similarly, the temporal layers may be arranged in any other alternate sequence without any deviation from the scope of the present disclosure. In an example embodiment depicted in FIG. 4B, consider that the NN layer 1, and the NN layer 2 are temporal layers, the NN layer 3 is a spatial layer, and the NN layer 4 is the temporal layer.

The neural network 400 includes one or more neural network layers, i.e., temporal layers 1 through N. As described above, the memory 301 is configured to implement the neural network 400 and store the plurality of basis function values for the corresponding neural network layer of the plurality of neural network layers 1 through N.

In one or more embodiments, the neural network 400 is configured to perform one or more encoded projection operations using one or more neural network layers of the neural network 400. A corresponding neural network layer of the neural network 400 includes a plurality of neurons. For example, the NN layer 1 includes a first plurality of neurons 403a, 403b, 403c through 403n (not shown), the NN layer 2 includes a second plurality of neurons 409a through 409i and so on, the NN layer 3 includes a third plurality of neurons 411a through 411n, and the NN layer 4 includes a third plurality of neurons 417a through 417n. A number of neurons at each of the neural network layers may be different. For example, a number of neurons at the NN layer 1 may be N1, a number of neurons at the NN layer 2 may be N2, a number of neurons at the NN layer 3 may be N3, and a number of neurons at the NN layer 4 may be N4. In some embodiments, the first plurality of neurons includes a first group of neurons by grouping any number of neurons within the same neural network layer.

In an implementation, the memory 301 is configured to allocate a first plurality of storage buffers 401a through 401n to a first group of neurons among the first plurality of neurons 403a through 403n of the NN layer 1. The memory 301 is further configured to store a plurality of group of first basis function values 402a through 402n each corresponding to a respective storage buffer among the first plurality of storage buffers 401a through 401n. In an implementation, the memory 301 is further configured to allocate a second plurality of storage buffers 405a through 405n (not shown) to a second group of neurons among the second plurality of neurons 409a through 409n of the next neural network layer (e.g., NN layer 2).

Likewise, the memory 301 is configured to allocate a fourth plurality of storage buffers 415a through 415n to a fourth group of neurons among the fourth plurality of neurons 417a through 417n of the NN layer 4. The memory 301 is further configured to store a plurality of group of fourth basis function values 413a or 413b corresponding to a respective storage buffer among the fourth plurality of storage buffers 415a through 415n.

Further, a configuration of the neural network 400 defines one or more connections between the plurality of neurons of the corresponding NN layers 1 through N. The neural processor 320 is configured to project input data sequences onto the basis function value by performing a series of operations on each of the input data sequences utilizing the storage buffer, and the basis function values. A detailed description of the series of operations for performing the encoder projection operation is described below with reference to FIG. 4 through FIG. 7.

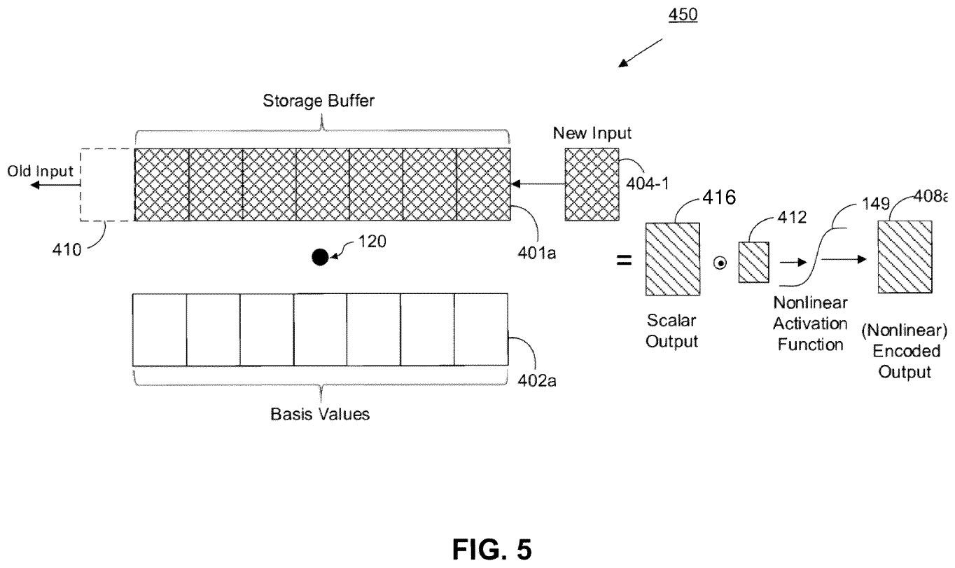

According to an example embodiment depicted in FIG. 4B, in the buffer mode, the storage buffer is configured to receive the input data sequence and process it by a sliding window operation that is described in FIG. 5 and FIG. 6. In an implementation, the input interface 303 is configured to receive, from corresponding input data sequences over a first sequence window, a first input data sequence 406a (i.e., new input at block 404-1) of the input data sequences into the storage buffers 401a allocated to the neurons 403a and 403b of the first group of neurons. In a non-limiting example, the sequence window may be a time window sequence. In the case of spatial data it is a spatial sequence window capturing sequences of spatial data. In the case of temporal or spatiotemporal data, the sequence window is a sequence time window capturing sequences of temporal or spatiotemporal data.

Similarly, the input interface 303 is configured to receive a second input data sequence 406b (i.e., a new input) into the storage buffer 401b allocated to the neurons 403c and 403d (not shown). According to the example embodiment, two neurons receive the same input data sequence, where the two neurons implement projection operation based on two different basis functions. In some embodiments, the first plurality of storage buffer may be collectively referred to as 401 without any deviation from the scope of the present disclosure. Similarly, the second plurality of storage buffer may be collectively referred to as 407 (not shown) included in the blocks 404-2. Likewise, the fourth plurality of storage buffer may be collectively referred to as 415. The first plurality of neurons in the NN layer 1 may be collectively referred to as 403. Similarly, the second plurality of neurons in the NN layer 2 may be collectively referred to as 409, the third plurality of neurons in the NN layer 3 may be collectively referred to as 411. Likewise, the fourth plurality of neurons in the NN layer 4 may be collectively referred to as 417. The first basis function values 402a and 402b may be collectively referred to as 402. Similarly, the fourth basis function values 413a through 413b may be collectively referred to as 413. According to the example embodiment shown in FIG. 4B, a sequence over basis function is repeated. For example, as may be seen for the neurons 430c, 403d the basis function 402a and 402b and is repeated. Likewise, for the neurons 419c and 419d the basis function 413a and 413b is repeated. Thus, the sequence over the basis function for different inputs gets restarted. The same can be envisaged for the example embodiment of FIG. 4B.

In some embodiments, each of the input data sequences of the sequential data is received and stored in each location of the storage buffer 401a over a time period for a particular time stamp (i.e., timebin). In a non-limiting example, the single sequential data may represent a single (spatial) bin, such as a single pixel of an image at an input layer, including the input data sequence that is received as a single bin (pixel) over the particular time stamp as depicted in FIG. 5. The process of performing the encoder projection operation with the storage buffer is shown in FIG. 5, where the procedure is simplified by considering only single-channel operation.

FIG. 5 illustrates the operations within a neural network layer including an encoder projection operation using the storage buffer in a single neuron for a single channel in a buffer mode operation, in accordance with some embodiments. In some embodiments, after the reception of the first input data sequence 404-1, the neural processor 320 is configured to perform a first dot product 120 of the first temporal sequence 404-1 with a corresponding basis function value 402a among the corresponding basis function values in the group of first basis function values 402. The input data sequences are stored within a corresponding storage buffer of the first plurality of storage buffers 401. In an implementation, the input data sequence is projected onto the basis function by performing the dot product for each connection of a corresponding neuron with a corresponding basis function value in the neural network layer. Referring to FIG. 4B, the dot product is performed between the input data sequences that are present in the storage buffer 401a and its corresponding basis function values 402a and 402b at neurons 403a and 403b, respectively. It is to be noted that in the example embodiment, neurons 403a and 403b receive the same input data sequence 401a, whereas neuron 403c receive a different input data sequence 401b. In an implementation, the basis function values are associated with a corresponding connection of the corresponding neuron or the corresponding set of neurons. For example, referring to FIG. 4B, the corresponding basis function values 402a are associated with a corresponding connection of the corresponding neurons 403a and 403c of the first group of neurons 403.

In some embodiments, the basis function values are discretized in timebins. The projection coefficients are used for generating a continuous function expressed as an expansion over projection coefficients multiplying a set of continuous basis functions. Each continuous basis function is then discretized in a number of timebins. The number of timebins is used herein to represent the values of the basis function and may match with a size of the storage buffer that holds the input, which thus has been discretized using the same size timebins and the same number of timebins. Once discretized in timebins, the projection coefficients or coefficients (aₙ(t) above or Cₙ(t) in FIG. 4A) of the projection are given by the dot product between the input signal and the basis function as given by equation 6 above.

In some embodiments, a single dot product is performed between the corresponding basis function value 402a in FIG. 5 or 402a in FIG. 4B or 402a in FIG. 4C and the corresponding input sequential data in the corresponding storage buffer 401a in FIG. 5 or 401a in FIG. 4B or 401a in FIG. 4C. In a similar manner, the neural processor 320 is configured to perform the dot product for the complete sequential data inputs to generate a corresponding output response as a result of each of the performed dot products. In other words, a corresponding potential value for the corresponding neuron 403a of the first group of neurons 403 is determined based on the performed first dot product 120 (FIGS. 4B, 4C, and 5). In some embodiments, the result of the corresponding first dot product 120 is a corresponding scalar output 416. As described herein above, the similar dot product operation is performed for the corresponding neurons 409a through 409i of the second group of neurons 409, the corresponding neurons 417a through 417n of the fourth group of neurons 417.

Once the dot product is performed, the neural processor 320 is configured to perform the multiplication of the result of the first dot product with a gain value to generate an intermediate output (i.e., intermediate response provided by neurons of the neural network layer 1 (NN layer 1) of the neural network 400. In some embodiments, the neural processor 320 may be configured to perform the multiplication of the result of the first dot product with a gain value and apply a cost function to the product to generate an intermediate output of the neural network 400. In such embodiments, the cost function may be configured to ensure sparsity in the intermediate output.

Specifically, according to an embodiment, FIG. 5, the neural processor 320 is configured to perform the scalar multiplication of the corresponding scalar output 416 with the corresponding gain 412. In some embodiments, after the determination of the intermediate response, the neural processor 320 is configured to apply, for the corresponding neuron 403a, one or more nonlinear activation functions 149 on the corresponding results of the corresponding scalar multiplication between the scalar output 416 with the corresponding gain 412. As an example, the one or more nonlinear activation functions 149 may itself be represented as a weighted sum over basis functions (e.g., orthogonal polynomials), with adaptive coefficients, or some typical pre-defined activation functions. In some embodiment, the application of the nonlinear activation functions is optional.

Based on a result of the application of the one or more nonlinear activation functions 149 on the corresponding results of the scalar multiplication of the corresponding intermediate output with the corresponding gain 412, the neural processor 320 is configured to generate the output response (encoded output response) for the corresponding neurons 403a of the group of neurons among the first plurality of neurons 403. In a non-limiting example, the neural processor 320 is configured to generate a first encoded output response 408 (as shown in FIGS. 4B, 4C and 5) based on the generated intermediate outputs. The output response 408 (encoded output response) is a nonlinear encoded output. According to an example embodiment depicted FIG. 4B, as a plurality of basis functions (e.g., 2) are used for performing the encoder projection operation by each neuron of the plurality of neural network layers, a plurality of encoded output is generated, in this case 408a. It is to be noted that for the sake of brevity, the encoded outputs generated from 403a are depicted collectively as 408a.

Referring to FIG. 4B, the encoded output 408a is passed to the next neural network layer, i.e., NN layer 2, where the NN layer 2 performs the encoder projection operation as explained with reference to FIG. 5. The output hence generated from the NN layer 2 is then passed to the NN layer 3 for performing spatial convolution. According to the example embodiment illustrated in FIG. 4B, the output of the NN layer 3 is then passed on to the next group of neurons. That is the output 156a of the neuron 411a is passed to 419a and 419b of NN layer 4, the output 156b of the neuron 411b is passed to the next set of neurons (not shown), and the like. Likewise, the NN layer 4 performs the encoder projection operation as explained with respect to the NN layer 1 and generates different encoded outputs 419a through 419d.

FIG. 4C illustrates another example representation of the neural network including a plurality of neural network layers and a plurality of neurons therein along with allocated corresponding storage buffers and corresponding basis function values, in accordance with some embodiments. In the example configuration of the neural network 430, neurons 403a, 403b and 403c receive same input 401a and perform projection operation using three corresponding basis functions. Similarly, neuron of NN layer 1 makes an output connection with the next three neurons of the next layer signifying use of three basis functions in layer 2 implementation as well. In a non-limiting example, the neuron 403a is connected with neurons 409a, 409b, and 409c. Based on the encoder projection operations as explained with reference to FIG. 5, the neuron 403a in the example configuration generates one encoded output response (shown as 408a for the sake of brevity) that is propagated to next layer neurons, i.e., 409a, 409b, and 409c. Similarly, the neuron 403b generates a different encoded output response (shown as 408b) that is propagated to the neurons, i.e., 409d, 409e, and 409f, and the neuron 403c generates an encoded output response (shown as 408c) that is propagated to the neurons, i.e., 409g, 409h, and 409i. Further, the neurons 409a through 409i generate encoded output responses 418a through 418i.

In some embodiments, the encoder projection operation may be performed for all the neurons in all of the neural network layers simultaneously in parallel. The encoder projection operation between the plurality of neural network layers occurring in parallel is explained in detail with reference to FIG. 6. In some embodiments, whenever the new input 404 is being received in the storage buffer 401, the old input 410 is discarded so that the new input 404 gets inserted and the other elements get shifted in the storage buffer 401 in each layer in a sliding window fashion. In particular, at each time step, the storage buffer 401 is updated by pushing the new input 404 to the storage buffer 401 and discarding the oldest input 410 from the storage buffer 401. This essentially applies the sliding-window over the input data stream to each layer in the buffer mode. The detailed operation of the shifting of the input sequential data in the storage buffer 401 will be explained with reference to FIG. 6. In some embodiments, a pointer corresponding to an address in the storage buffer 401 may get shifted instead of actually shifting all of the elements inside the storage buffer 401.

FIG. 6 illustrates a detailed operation of shifting input data in the storage buffer in the buffer mode operation according to some embodiments. Operation 700 illustrates operations of shifting the input data into the storage buffers in the neural network layer 1 and the neural network layer 2 during the encoded projection operation. In the example illustrated in FIG. 6, the storage buffer of the neural network layer 1 has a buffer size of 13 and has N1, O1 to O13 portions of the input data. Further, the portion of the input data O1 to O13 indicates an older portion of the encoder projection operation. When a new portion of the input data N1 is received at the storage buffer, the oldest portion of the input data O13 is discarded and the neural processor 320 may shift the contents or pointer of the storage buffer so as to store the new portion of the input data N1 in the storage buffer. Further, at the first time processing 702, the neural processor 320 may generate an output encoded response based on the encoded projection operation of the portions of the input data N1 to O12 with the plurality of basis function values. The generated output encoded response is then passed on to the storage buffer of the next neural network layer 2. When the new portion of the input data N2 is received at the storage buffer of the neural network layer 1, the oldest input data portion O12 is discarded and the neural processor 320 may shift the contents or pointer of the storage buffer so as to store the received new portion of the input data N2 in the storage buffer.

At the second time processing 704, the neural processor 320 may generate an encoded output response based on the encoded projection operation of the portion of the input data N2 to O11 with the plurality of basis function values. The generated encoded output response is then passed on to the storage buffer of the next neural network layer 2. Likewise, when the next new input portion N3 is received at the storage buffer of the neural network layer 1, the oldest portion of the input data O11 is discarded and the neural processor 320 may shift the contents or pointer of the storage buffer so as to store the received new portion of input data N3 in the storage buffer.

At the third time processing 706, the neural processor 320 may generate an encoded output response based on the encoded projection operation of the portion of the input data N3 to O10 with the plurality of basis function values. The generated encoded output response is then passed on to the storage buffer of the next neural network layer 2. Likewise, when the next new portion of the input data N4 is received at the storage buffer of the neural network layer 1, the oldest input data portion O10 is discarded and the neural processor 320 may shift the contents or pointer of the storage buffer so as to store the received new portion of the input data N4 in the FIFO buffer.

At the fourth time processing 708, the neural processor 320 may generate an output response based on the encoded projection operation of the portion of the input data N4 to O9 with the plurality of basis function values. The generated encoded output response is then passed on to the storage buffer of the next neural network layer 2. The process of shifting the input data and discarding the oldest input data in the storage buffer continues as the new portion of the input data is streamed. Although the shifting process is explained with the example of NN layer 1 and the NN layer 2, the same process may be applied to any number of neural network layers present in the neural network 400.

In some embodiments, based on system requirements or user defined requirements, a group of basis function values may be selected. Accordingly, the neural processor 320 may be further configured to recognize, based on a selection of a corresponding group of the first basis function values, a change in a response pattern of one or more neurons in the group of neurons among the first plurality of neurons over a time period. Thereafter, the neural processor 320 may be further configured to update the first basis function values based on the recognized change in the response pattern.

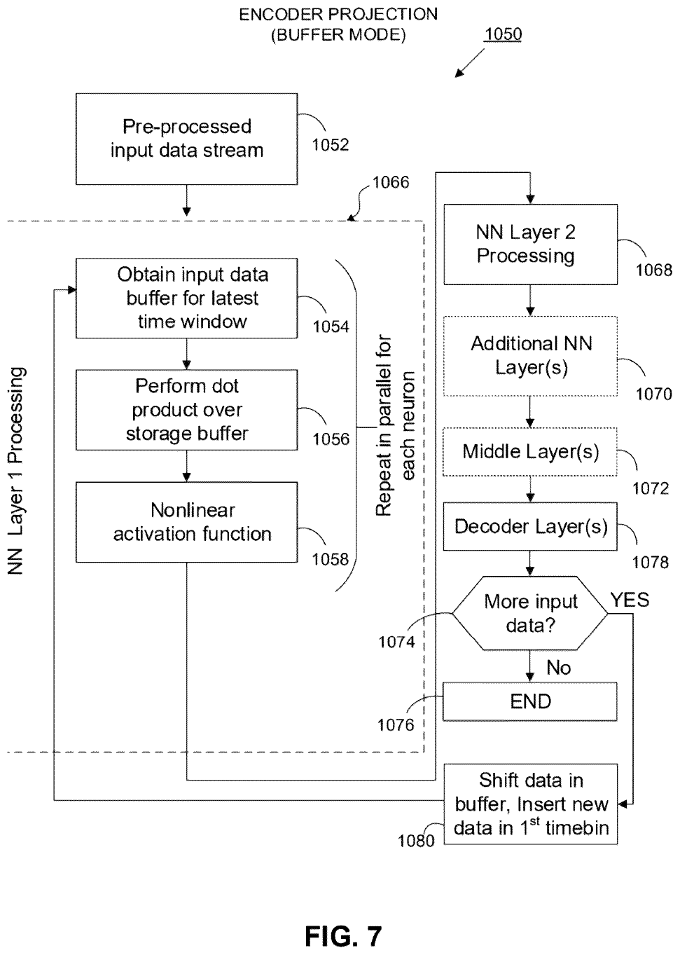

FIG. 7 is a flow chart of a method 1050 performed by a processing system 300 including the neural processor 320 for performing encoder projection operations in the buffer mode using one or more neural network layers of the neural network 400, in accordance with some embodiments. In block 1052 of the method 1050 the processing system 300 may perform operations including receiving a pre-processed input data stream at the input interface 303 of the neural network system 300. As an example, the neural processor 320 may read the pre-processed input data stream that is received at the input interface 303 of the neural network system 300. The received input data stream may typically include sequential input data (input data sequence), generally read by the neural network 400 as the input stream of 3D tensor data. In a non-limiting example, the received input data stream may be generated by frame-based cameras providing RGB color channels at specific frame rates. In another non-limiting example, signals from event-based cameras may also be used as the input data stream but may require preprocessing such that one event may contribute to one or more timebins in order to provide a 4D tensor data format such as channel (1D), space (2D) and time (1D).

For example, if the camera is frame-based, then the stream of frames captured by the camera may be directly fed into the spatiotemporal neural network 400 in the form of a 4D tensor of size (RGB channels)×(number of pixels along sensor's width)×(number of pixels in sensor's height)×(number of frames). In another example, if the camera is event-based, then preprocessing may be performed on the input data stream to convert the input data stream into a 4D tensor. In another example, the input data stream may be generated based on text input data.

In some embodiments, the neural processor 320 may be configured to process the received input data stream for each channel or combination of channels as inputs to the neural network 400. In some embodiments disclosed herein, the neural processor 320 processes one or more of the channels of the input data stream i.e., 4D tensor data. However, in some embodiments, the neural processor 320 may process each of the channels internal to the neural network 400 by processing, aggregating, and combining the results of the encoder projection operations for every channel path, i.e., for each of the channels in the neural network 400. The neural processor 320 processes the received input data stream through a neural layer 1 processing block 1066 (surrounded by dashed box) followed by a NN layer 2 processing block 1068 and additional NN layer(s) block 1070. It is to be noted that the neural layer 1 processing block 1066, the NN layer 2 processing block 1068 and the additional NN layer(s) block 1070 as shown in FIG. 7 are for illustration purpose only and should not be construed as limiting in nature for a person skilled in the art.

In some embodiments, the operations in the neural network layer 1 in processing block 1066 include one encoder projection operation followed by one non-linear activation functions. In some embodiments, the first neural network layer 1 processing block 1066 may contain more than one encoder projection operation. In some embodiments, the encoder projection operation is applied separately to each time bin (pixel) of each input data stream, and thus, by processing in one encoder projection operation, in time of the same time bin (pixel). The neural processor 320 performs the encoder projection operation at a particular time step for each neuron of each of the one or more neural network layers 1 through N sequentially or in parallel.

The method operations in blocks 1054 to 1058 of the method 1050, correspond to operations performed by the neural processor 320 in the neural network layer 1 processing block 1066. In block 1054, the neural processor 320 obtains, from the received input data stream (i.e. input data sequences), at the first time instance. In block 1056, the neural processor 320 performs a dot product of the corresponding basis function over the corresponding storage buffer to perform a projection of the input data sequences onto each of the basis function through the one or more neural network layers 1 through N of the neural network 400. Thus, the dot product is performed on the obtained input data sequence in the storage buffer with a corresponding basis function value of the one or more neural network layers 1 through N of the neural network 400. After performing the dot product, scalar output is generated from each of the dot product operations. A detailed explanation related to the method operations in block 1056 is already described above with regard to the encoder projection operation 450 illustrated in FIG. 5. Therefore, for the sake of brevity of the disclosure, the detailed explanation of the same is omitted here. Thereafter, the neural processor 320 is configured to perform scalar multiplication of the scalar output with the gain value.

In block 1058, the neural processor 320 is configured to apply the one or more nonlinear activation functions 149 on the resultant scalar multiplication of the scalar output with the gain value to convert the resultant scalar multiplication of the scalar output with the gain value into one or more nonlinear encoded output values. In a non-limiting example, the one or more nonlinear activation functions 149 may include a Rectified Linear Unit (ReLU) activation function or a sigmoid function. The operations in blocks 1054 through 1058 are repeated in parallel for each neuron as the dot product is performed over different time bin.

When the operations in blocks 1052 to 1058 of the NN layer 1 processing block 1066 are performed for the input data sequence at the first time instance, the encoded output response from the NN layer 1 processing block 1066 is passed onto the NN layer 2 processing block 1068. After completion of the processing at the additional NN layer(s) 1070, the neural processor 320 may perform post-processing of the encoded output responses at a middle layer(s) processing block 1072 for overall neural network 400 for the current time instance. Once each of the non-linear encoded output values is generated, the neural processor 320 passes on the generated non-linear encoded output values to one or more decoder layers 1078 of the neural network 400 as an input.

In addition, to take advantage of parallel processing hardware, the NN layer 1 processing block 1066 may be configured to fetch data from the next time instance (if available) while NN layer 2 processing blocks 1068, 1070, and 1072 may still process the output encoded response from the current time instance. As an example, in block 1074, the neural processor 320 determines whether more input data sequence is available at the input interface 303 after completing the processing at the NN layer 1 processing block 1066. If in block 1074 it is determined that more input data is available, then in block 1080 the neural processor 320 shifts the data in the storage buffer and inserts the new available data in the first timebin of the storage buffer for further processing. The same applies to other NN layer 2 processing blocks 1068, 1070, and 1072 of the neural network 400. This method of processing input data sequences at different time instances at successive NN layers may be referred to as pipelining without any deviation from the scope of the present disclosure.

Further, if in block 1074, it is determined that no more input data is available, the method 1050 comes to an end in block 1076.

FIG. 8 illustrates an example representation of the neural network 500 including a plurality of neural network layers and the plurality of neurons along with the working of the neural network 500 in the recurrent mode, in accordance with some embodiments. The neural network 500 includes one or more neural network layers including neural network layers, for example, NN layer 1, NN layer 2, . . . , NN layer N.

In addition, the memory 301 is further configured to implement the neural network 500 and store a plurality of gain values for a corresponding neural network layer of the plurality of neural network layers 1 through N (i.e., NN layers 1 through N). It is to be noted that the gain values may be different for each neuron of the neural network 500. The memory 301 is further configured to store a memory tensor 140 as an internal state of the corresponding neural network layers and a first set of projection tensors or gain values, which may also be referred herein as the reference tensors 141a, 141b, 141c, . . . , 141n. A projection tensor 141 projects the input data 102 onto a set of basis functions that are used in a dimensional expansion or contraction of the inputs. Also, to update the memory tensor 140, the memory 301 is configured to store a second set of coefficients as a state operator or a reference tensor 144 that is used to generate the basis functions. The reference tensor 144 and the projection tensor 141 are determined based on one or more basis functions that are used to construct one or more complex functions, and a set of parameters, such as the gain values, that evolve through training without specific interpretations.

The neural network 500 is configured to perform one or more projections using one or more neural network layers of the neural network 500. In particular, the neural network 500 is configured to perform hierarchical projection processing. A corresponding neural network layer of the neural network 500 includes a plurality of neurons. In a non-limiting example, the neural network layer 1 includes a first plurality of neurons 501a through 501n, and the neural network layer 2 includes a second plurality of neurons 503a, 503b, . . . , 503i, . . . , 503n. It is to be noted that reference numerals 501n and 503n are not shown explicitly in FIG. 8 for the sake of simplicity of the example illustration. The sequence of the plurality of neural network layers as shown in FIG. 8 is exemplary and is not intended to limit the scope of the of the present disclosure or the claims. For example, the neural network layer 1 may be arranged before or after any of the neural network layers 2 or other neural network layer of the neural network 500. Accordingly, the corresponding neural network layers 1 through N may be arranged in any other alternate sequence without any deviation from the scope of the present disclosure.

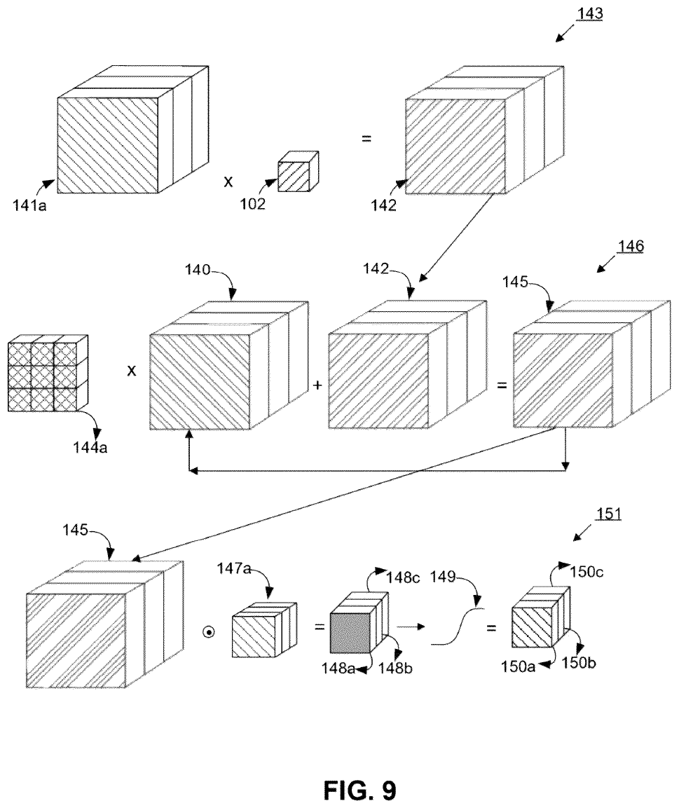

Further, a configuration of the neural network 500 defines one or more connections between the plurality of neurons of the corresponding neural network layers 1 through N. The neural processor 320 may be configured to perform the one or more temporal projections using neurons of the one or more neural network layers of the neural network 500. In particular, neural processor 320 may be configured to perform the one or more projections by performing a series of operations on each of the data sequences utilizing the plurality of reference tensors (141a, 141b, 141c, . . . , 141n, 144a, 144b, 144c, . . . , 144n), the memory tensor 140, and the plurality of gain values 147a, 147b, 147c, . . . , 147n (hereinafter may also be referred to as 147 for the ease of explanation). A detailed description of the series of operations for performing the projection is provided below with reference to FIG. 9.

Further, in some embodiments, in the recurrent mode the neural processor 320 may be configured to project one or more input data sequences onto higher dimensional basis functions or project a large array of input data sequences onto lower dimensional basis functions. Further, the neural processor 320 may be configured to transform each of the memory tensors and utilize them for encoding the results of the projections, where each state represents the coefficient of the projection in a transformed space. The neural processor 320 performs element-wise multiplication of the encoded results of the projections with gain values. The application of gain values enables the projection of the input(s) to be made onto nearly arbitrarily constructed functions represented over the series of basis functions. By providing the coefficients as the neuron outputs of the layers, the next layers have a better representation to manipulate projection coefficients in comparison to if the coefficients have been collapsed together, such as in a conventional convolution operation. Further, the mid-layers of the neural network 500 are then capable of taking full advantage of the better representation by operating on such distributed sets of projection coefficients (i.e., neural activity).

The representation of the input through projection coefficients distributed across the network as neural activity allows the encoding by projection coefficients to span over a long time-window while being parameterized by only a few gain coefficients.

In particular, the neural activity representing the projection coefficients may be used directly in the recurrent mode for efficient online inference. This is especially useful for mobile devices and edge computing to perform projections at every bin instance (time bin or spatial bin). Thus, the neural network 500 of some embodiments employs projection operations configured as linear recurrent operations in nonlinear neural network layers that may be used to perform efficient online inference over a data stream, in contrast to conventional recurrent neural networks that have nonlinear recurrent operations.

Each of the neural network layers 1 through N of the neural network 500 may be configured to perform a projection between the basis functions and the inputs. The projections between the basis functions providing for the projection coefficients through neural activity and the inputs is a linear operation. Thus, the neural network 500 may be trained efficiently utilizing GPU hardware similar to CNNs. The training of the neural network 500 may be performed using optimization algorithms such as but not limited to adaptive moment estimation (Adam).

The gain values may be trained along with the entire neural network 500 in an end-to-end fashion, while the basis functions, which may be orthogonal polynomials, may be kept fixed or may be trained as well. That is the reference tensors (projection tensors 141a, 141b, 141c, . . . , 141n) and (gain values 147a, 147b, 147c, . . . , 147n) shown in FIG. 9 may be constituted or not of trainable parameters. In some embodiments, the number of the gain values may be much smaller than the number of bins over which the basis functions are defined, thus fewer than the number of basis function values, once the basis function is segmented into discrete bins. Thus, the number of trainable parameters may be made much less than associating a weight parameter to each discrete bin.

The neural network 500 may be further configured to operate in a fixed and uniform discrete bin size (τb) throughout the network, or the neural network 500 may be further configured to operate in a variable or non-uniform bin size, depending on the one or more embodiments disclosed herein. In some embodiments, the bin may represent a timebin. In other embodiments, the bin may be a spatial bin, and in further embodiments, a bin in other discretized dimension(s).

In some embodiments, the neural activity encoding projection coefficients of the corresponding neural network layers of the neural network 500 may be defined on a finite time interval. Thus, each neural output may represent the projection of the input onto basis functions, some of which may be orthogonal, some of which may be orthogonal polynomials defined on a finite interval on a real line, such as the Legendre, Chebyshev, Gegenbauer, or Jacobi polynomials. The orthogonality condition of such polynomials may be defined through a “weight” function.

FIG. 9 illustrates an example scenario depicting a method of performing encoder projection at neural network layer 1 of the neural network 500 in the recurrent mode, in accordance with some embodiments. It is to be noted that only one input channel and one output channel are considered for the description of the method of performing encoder projection at neural network layer 1, the ease of explanation, and the sake of brevity of the present disclosure.

The method shown in FIG. 9 is divided into two processing stages i.e., a recurrent stage 143 and 146 and a feedforward stage 151. In a first portion 143 of the recurrent stage, the neural processor 320 first receives a data point of current bin 102. Secondly, the neural processor 320 projects the received data point 102 by the reference tensors 141a, 141b, 141c, . . . , 141n (i.e., the projection tensors 141a, 141b, 141c, . . . , 141n), respectively, and thereby determines a projected input 142. Further, in a second portion 146 of the recurrent stage, at first, for the received data sequence 102, the neural processor 320 transforms the memory tensor 140 by multiplying the memory tensor 140 with the reference tensors 144a, 144b, 144c, . . . , 144n, respectively. Secondly, the neural processor 320 generates an updated memory tensor 145 by adding the transformed memory tensor with the projected input 142. In other words, the neural processor 320 updates the internal state of the recurrent layer by adding the projected temporal input 142 to the current internal state of the recurrent layer.

In the feedforward stage 151, the neural processor 320 performs, for each connection associated with a corresponding neuron of a group of neurons among the plurality of neurons 501a through 501n at the recurrent layer, an element-wise multiplication of the updated memory tensor 145 with the plurality of gain values 147. The element-wise multiplication is performed to pass information of the current recurrent layer as output to the next layer of the neural network 500, for example, another recurrent layer of the neural network 500. Also, as can be seen in FIG. 9, results of the performed element-wise multiplication of the memory tensor 145 and the plurality of gain values 147 i.e., scalar values 148a, 148b, and 148c may be given as the output to the neural network layer 2. More specifically, in the feedforward stage 151, the memory tensor 145 i.e., the new internal state is directly multiplied with the gain values 147 instead of the basis function values, which performs the temporal projection in the coefficient space and thus yields the output values 148a, 148b, and 148c. This obviates the need to explicitly compute or store the basis function values.

Further, in the feedforward stage 151, the neural processor 320 determines a corresponding potential value for the corresponding neurons based on the performed element-wise multiplication of the updated memory tensor 145 and the plurality of gain values 147. In order to determine the corresponding potential value for the corresponding neurons, at first, the neural processor 320 applies one or more activation functions 149 (herein also referred to as a nonlinear activation function 149) on corresponding results i.e., 148a, 148b, and 148c of the scalar multiplications. Thereafter, the neural processor 320 determines the corresponding potential value for the corresponding neurons based on a result of the application of the one or more activation functions 149 on the corresponding results of the element-wise multiplications. Further, after determining the corresponding potential value for the corresponding neurons, at last, the neural processor 320 generates a plurality of encoded output responses 150a, 150b, and 150c corresponding to the neural network layer 1 based on the determined corresponding potential values of the corresponding neurons. It is to be noted that the neural processor 320 may use a different set of temporal coefficients to connect each input and output channel pair, and the results of the corresponding element-wise multiplications may be used to generate the plurality of encoded output responses 150a through 150c for each output channel.

Similarly, the neural processor 320 may determine the corresponding potential value for the corresponding neurons at the neural network layer 2 based on the element-wise multiplication of the updated memory tensor 145 and the plurality of gain values 147 corresponding to the neurons of the neural network layer 2. Accordingly, in a non-limiting example, the neural processor 320 may further generate the plurality of encoded output responses 150d, 150e, and 150f corresponding to the neural network layer 2 based on the determined corresponding potential values of the corresponding neurons.

In the recurrent mode, the neural network 500 stores a compressed representation of the past inputs (i.e., internal state) at each of the recurrent layers 1 through N, and thus maintains and updates the internal state of each of the recurrent layers 1 through N. Further, the memory and computation requirements of the neural network 500 are scaled with the dimensions of the reference tensor 144, and thus, the number of gain values. Therefore, the neural network 500 can be trained efficiently and the neural network 500 may perform the inference over long temporal data sequences on the fly with high accuracy in comparison to conventional RNNs.

For illustration purposes only, FIG. 9 only depicts the recurrent operations performed by the neural processor 320 for a single channel. However, the neural processor 320 may perform the projection operations for multiple input and output channels in a similar manner as described with reference to FIG. 9. For example, the neural processor 320 may receive multiple data sequences separately for the multiple input channels. For example, the neural processor 320 may project the reference tensor 141a onto the received data to the second input channel and thereby may determine another projected sequential input 142 based on the projection of the data by the reference tensors 141a. Further, for the data received to the second channel, the neural processor 320 may transform the updated memory tensor 145 by multiplying the reference tensor 144a with the updated memory tensor 145. Thus, the neural processor 320 may generate a new memory tensor by adding the transformed updated memory tensor with the determined projected input 142. Taken over all the channels, in the feedforward stage 151, the neural processor 320 may perform, for each connection associated with the corresponding neuron of the group of neurons among the plurality of neurons 501a through 501n, a new element-wise multiplication of the newly generated memory tensor with the plurality of gain values 147a, 147b, 147c, . . . 147n. Also, the neural processor 320 may store the updated memory tensor 145 or the newly generated memory tensor in the memory 301 at each consecutive time instance when the new memory tensor is generated.

In some embodiments, in the recurrent mode the neural processor 320 may further transform the newly generated memory tensor at a consecutive bin instance at which a new data sequence of the data sequences is received at the input channel. Also, the neural processor 320 may repeatedly generate the new memory tensor until the updated memory tensor is transformed for each of the temporal data sequences received at the input channel.

Further, the plurality of encoded output responses 150a, 150b, and 150c corresponding to each of the output channels may be passed to another neural network layer (for example, NN layer 2). Similarly, the neural processor 320 may generate another plurality of encoded output responses 150d, 150e, and 150f corresponding to each of the output channels and which may be further passed to next neural network layer, for example, NN layer 3 (not shown) of the neural network 500.

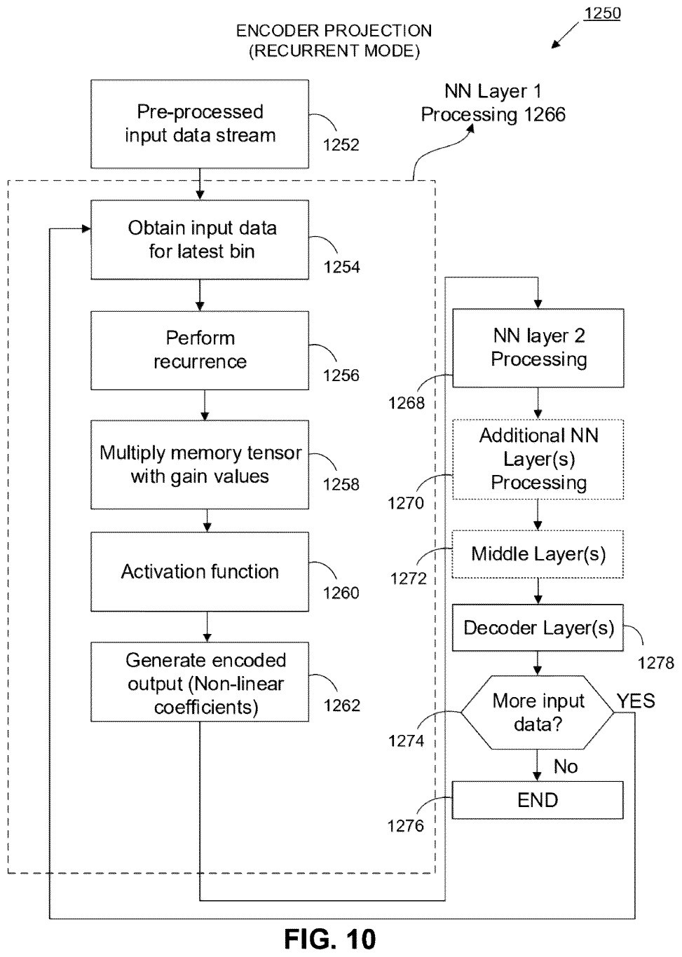

FIG. 10 is a flow chart of a method 1250 performed by the neural processor 320 for performing, in the recurrent mode, encoder projection, mid-layer processing, and decoding which generates content using one or more neural network layers of the neural network 500, in accordance with some embodiments. The method 1250 (in block 1252), includes receiving a pre-processed input data stream at the input interface 303 of the neural network system 300. As an example, the neural processor 320 may read the pre-processed input data stream that is received at the input interface 303 of the neural network system 300. The received input data stream may typically include sequential input data generally read by the neural network 500 as an input stream of tensor data. The neural processor 320 may be configured to process the received input data stream for each combination of the channel interaction of the channels of the neural network 500. In some embodiments the neural processor 320 processes one of the channels of the input data stream. However, in some embodiments the neural processor 320 may process each of the channels of the input data stream for each of the channel interactions in the neural network 500.

The neural processor 320 processes the received input data stream through a neural network layer 1 processing block 1266 (surrounded by dashed box) followed by a NN layer 2 processing block 1268, additional NN layer(s) processing block 1270, and middle layer(s) processing block 1272. It is to be noted that the neural network layer 1 processing block 1266, the second NN layer 2 processing block 1268, the additional NN layer(s) processing block 1270, and the middle layer(s) processing block 1272 as shown in FIG. 10 are for illustration purposes only and may not be construed as limiting in nature for a person skilled in the art.

In some embodiments, the operations in the first neural network layer 1 processing block 1266 may include one projection operation followed by non-linear activation functions. In some embodiments, the neural network layer 1 processing block 1266 may contain more than one consecutive projection operation. The projection step is applied separately to each bin of each discretized input bin (frame, tensor) of the input data stream. The neural processor 320 may perform the projection at a particular bin step at each of the one or more neural network layers, for example, NN layers 1 through N sequentially or in parallel.

The method operations in blocks 1254 to 1262 of the method 1250, correspond to operations performed by the neural processor 320 in the neural network layer 1 processing block 1266. In block 1254, the neural processor 320 obtains, from the received input data stream, first input data as the first data sequence at the first bin instance. In block 1256, the neural processor 320 performs a recurrence on the obtained first data sequence to update the internal state of the one or more neural network layers 1 through N (NN layers 1 through N) of the neural network 500. In block 1258, the neural processor 320 performs a element-wise multiplication operation of multiplying the updated memory tensors with one or more gain values 147a, 147b, 147c, . . . , 147n to generate one or more encoded output values. As an example, for performing the multiplication of the updated memory tensors with one or more gain values 147a, 147b, 147c, . . . , 147n, the neural processor 320 transforms, for the first data sequence, the memory tensor 140 based on the tensor multiplication of the reference tensor 144a with the memory tensor 140 and thereby generates the updated memory tensor 145 (i.e., updated internal state) based on the transformed memory tensor and the projected input 142. Thereafter, the neural processor 320 performs, for each connection associated with a corresponding neuron of a group of neurons among the plurality of neurons at each of the neural network layers 1 through N, an element-wise multiplication of the updated memory tensor 145 with the plurality of gain values 147a, 147b, 147c, . . . , 147n.

In block 1260, the neural processor 320 applies the one or more activation functions 149 on the one or more scalar multiplication output values to convert the one or more scalar multiplication output values into one or more nonlinear encoded output values (i.e., non-linear coefficients). In a non-limiting example, the one or more activation functions 149 may include ReLU or a sigmoid function.

When the operations in blocks 1252 to 1262 of the first neural network layer 1 processing block 1266 are performed for the first temporal data sequence of the temporal data sequences at the first time instance, output data from the first neural network layer 1 processing block 1266 is passed onto the second neural network layer processing block 1268 (i.e., NN layer 2 processing block). Similarly, the output data from the second neural network layer processing block 1266 is passed onto the additional neural network layer(s) processing block 1270 for generating another set of non-linear encoded output values. Further, after completion of the processing at the additional neural network layer(s) processing block 1270, the neural processor 320 performs post-processing of the output data at middle layers processing in block 1272 for overall neural network 500 for the current time instance. Once each of the non-linear encoded output values is generated, the neural processor 320 passes on the generated non-linear encoded output values to one or more decoder layers 1278 of the neural network 500 as an input.

In addition, to taking advantage of parallel processing hardware, the first neural network layer 1 processing block 1266 may be configured to fetch data from the next bin instance (if available) while subsequent neural network layer processing blocks 1268 and 1272 may still process the output data from the current time instance. As an example, in block 1274, the neural processor 320, may determine whether more input data is available at the input interface 303 after completing the processing at the first neural network layer 1 processing block 1266. If in block 1274 it is determined that more input data is available, the neural processor 320 may obtain the next available data point in the sequence in block 1254 of the first neural network layer 1 processing block 1266 for further processing. The same applies to other neural network layer processing blocks 1268 and 1272 of the neural network 500. This method of processing different bin instances at successive neural network layer processing blocks may be referred to as pipelining without any deviation from the scope of the present disclosure.

Further, if in block 1274 it is determined that no more input data is available, the method 1250 comes to an end in block 1276.

It is to be noted that the flow of the projection operations in the form of sequenced neural network layer processing blocks is merely exemplary. Therefore, in some embodiments, the flow of the projection operations may be represented in a sequence that is different from the neural network layer processing blocks sequence.

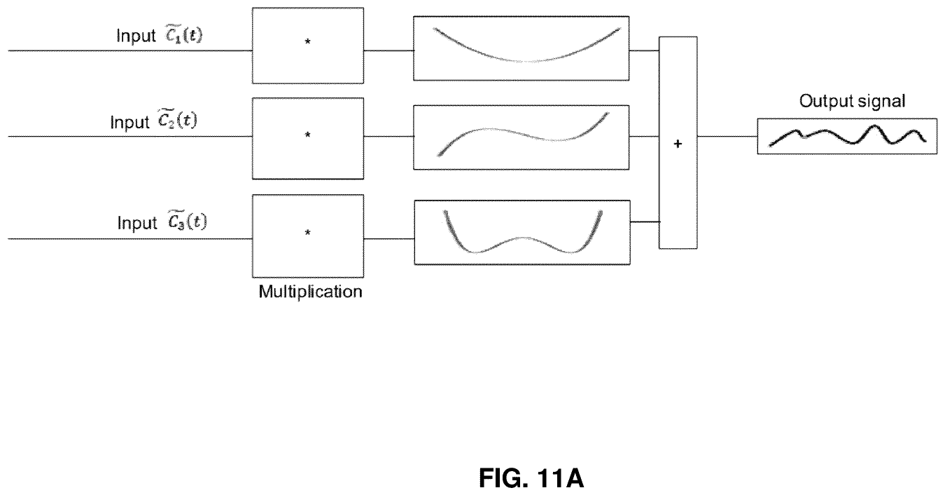

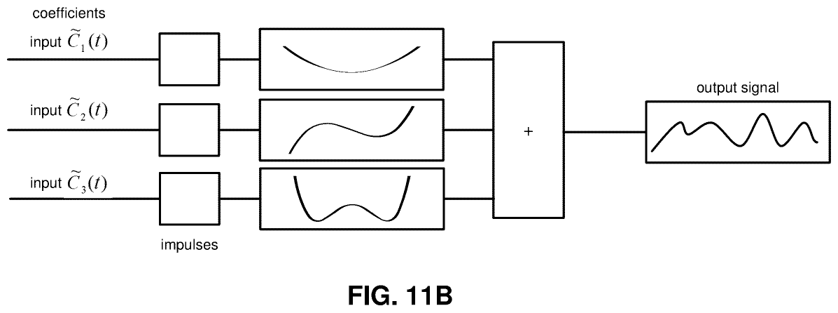

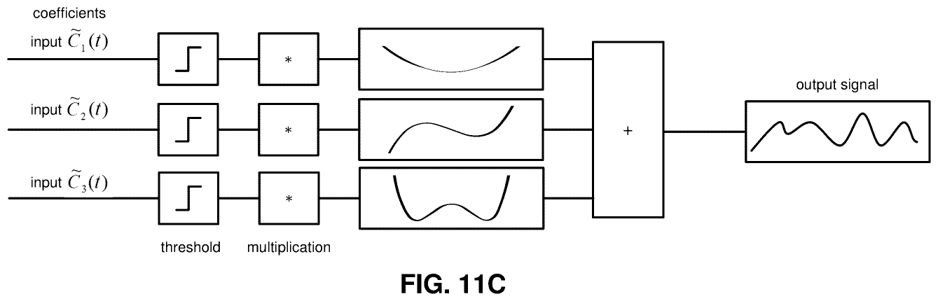

FIG. 11 illustrates an example embodiment method of performing decoder operation for signal and content generation at the corresponding neural network layer of the neural network in the buffer mode, in accordance with some embodiments. For performing the decoder projection, the neural processor 320 builds a decoder output by performing an inverse transform operation, which is a linear sum of the basis functions weighted by coefficients. These coefficients are determined by the output of the encoder neural network layers of the neural network 500.

As described above, that the generated non-linear encoded output values are passed by the neural processor 320 to the one or more decoder layers 1278 of the neural network 500 as the inputs, for example, \tilde{C}₁(t), \tilde{C}₂(t), and \tilde{C}₃(t). These inputs may also be referred to as input coefficients for the decoder layers of the neural network. To perform the decoder projection, the neural processor 320 first performs multiplication of the encoded inputs with the plurality of basis functions to generate a plurality of decoded responses. Upon the generation of the plurality of decoded responses, the neural processor 320 assembles the generated plurality of decoded responses and sums them together to generate a single output response i.e., (output signal or reconstructed signal). The generated signal may be given by equation 8:

$$f ( t ) = {\sum }_{n} {\sum }_{τ = t - Δ}^{t} {\tilde{C}}_{n} ( τ ) {y}_{n} ( τ ) \qquad ( 8 )$$

where, \tilde{C}ₙ(τ) corresponds to coefficients of the basis functions yₙ(τ) used to generate the output signal ƒ(t).

In neural networks using convolutions to generate output signals, a neuron output being a scalar convolution, a(τ), takes the role of coefficients of a convolution kernel h(τ), to generate an output signal ƒ(t) as shown in equation 9:

$$f ( t ) = {\sum }_{τ = t - Δ}^{t} a ( τ ) h ( τ ) \qquad ( 9 )$$

If the kernel is defined by an expansion over basis functions, Σₙ, Gₙ, yₙ(τ), the generated output signals is given by equation 10:

$$f ( t ) = {\sum }_{n} {G}_{n} {\sum }_{τ = t - Δ}^{t} a ( τ ) {y}_{n} ( τ ) \qquad ( 10 )$$

As revealed by comparing this later signal generation with the signal generation of this disclosure, the coefficients \tilde{C}ₙ(τ) in Eq. 8 above may be approximated by Gₙ a(τ) of Eq. 10, where a(τ) is a single time-varying scalar quantity being weighted by the trained kernel coefficients Gₙ. Thus, such the single time-varying scalar quantity a(τ) does not compare to the greater representation of the n time-varying scalar quantities \tilde{C}ₙ(τ).

A generated output signal can thus be more quickly constructed because the generated signal is constructed by weighting differentially each of the basis functions yₙ(τ) with \tilde{C}ₙ(τ), which may vary at any point in time, individually. Thus, each coefficients \tilde{C}ₙ(τ) is independent of the others and can take on any arbitrary values in time τ, whereas each of the coefficients with a convolution generated output has one common time-varying scalar a(τ). The transform network for signal generation is thus expected to be more efficient in requiring less layers and less neurons to achieve the same signal generation.

Therefore, a larger variability of the generated output responses may be achieved and hence the method and system disclosed above becomes more efficient for generating precise content than a convolution network given the same amount of computation.

FIG. 11B illustrates an alternative embodiment method in which instead of performing multiplication of the encoded inputs with the plurality of basis functions to generate a plurality of decoded responses, the neural processor 320 extracts impulses from the coefficients \tilde{C}₁(t), \tilde{C}₂(t), \tilde{C}₃(t) that are applied to or used to select the basis functions that are combined to produce the output signal. Using impulses (essentially 1 or 0 depending on whether an impulse is detected or present in the coefficient) may reduce the amount of mathematical operations performed by each neural network layer as only those basis functions correlated to an impulse need to be added to generate the output signal.

FIG. 11B illustrates an alternative embodiment method in which the coefficients \tilde{C}₁(t), \tilde{C}₂(t), \tilde{C}₃(t) are passed through a threshold function so that only those components with a signal component satisfying the threshold are multiplied by the basis functions before being added to generate the output signal. Similar to the embodiment illustrated in FIG. 11B, this embodiment may reduce the amount of multiplication operations performed by the neural network layer as only those signals with a significant value (i.e., satisfying the threshold function) are multiplied times the basis functions.

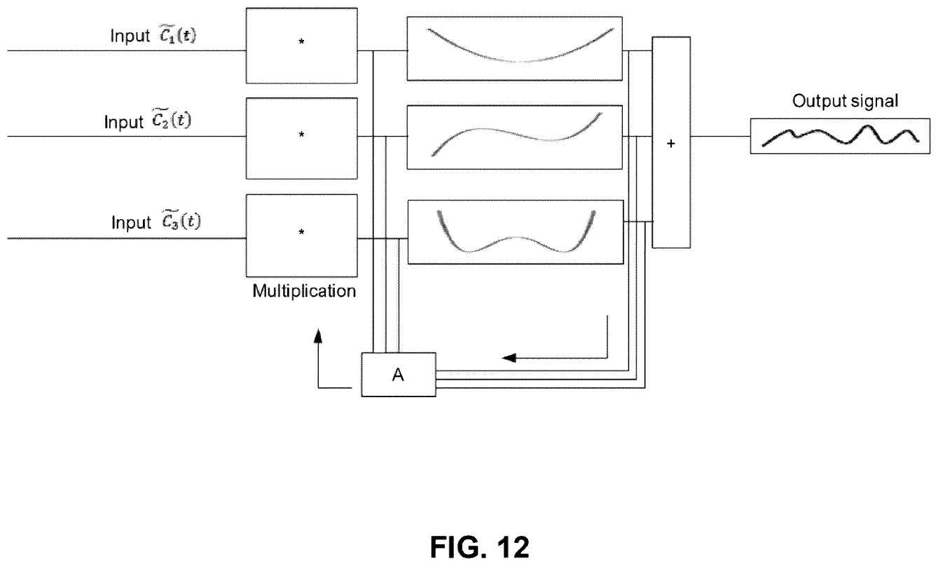

FIG. 12 illustrates an example embodiment method of performing the decoder projection for signal and content generation at the corresponding neural network layer of the neural network in the recurrent mode, in accordance with some embodiments.

The method for performing the decoder projection in the recurrent mode is similar to that of the decoder projection in the buffer mode but differs in terms of the presence of state operator A for generating the basis functions along the incoming sequence. The state operator A may be well defined for given basis function polynomials from their recurrence relation and may be used as an initial tensor for a trainable state operator. As aforementioned, the generated non-linear encoded output values is passed by the neural processor 320 to the one or more decoder layers 1278 of the neural network 500 as the inputs, for example, (\tilde{C}₁(t), \tilde{C}₂(t), and \tilde{C}₃(t). To perform the decoder projection in the recurrent mode, firstly, the neural processor 320 performs multiplication of the encoded inputs with the plurality of basis functions. Once the multiplication operation is performed, the neural processor 320 determines and provide, based on results of the multiplication operation, a recurrent relationship of the basis functions through the state operator A to the neurons of the decoder layers as an input to generate the plurality of decoded responses. Thereafter, the neural processor 320 assembles and sums the plurality of decoded responses to generate a generative output response (i.e., the output signal).

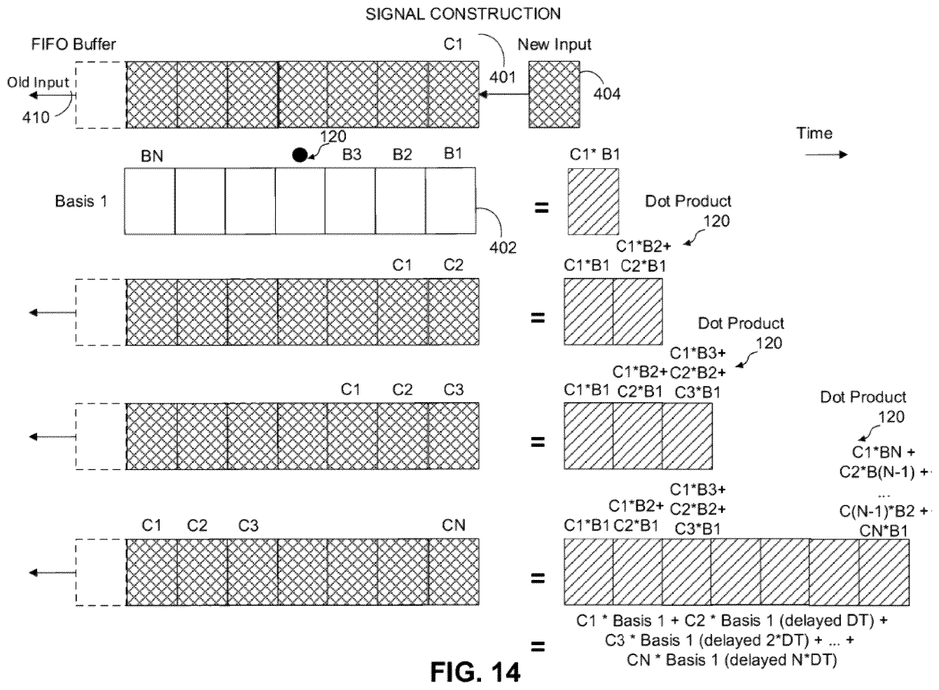

FIGS. 13-14 illustrates a future response prediction operation of neurons in the neural network according to some embodiments. In some embodiments, the operations depicted in FIG. 13 describe a method of predicting future responses of the neurons based on a current sparse activity of the neurons. When the neuron activity is sparse, the output responses of the neurons into the future may be directly predicted up to the length of the basis function without any need to iterate. Thus, in some embodiments, it is possible to forecast the output of a neuron until the length of the basis function into the future. This is particularly of value if the input activity, the input coefficients to the decoder layer, have limited or sparse neuronal activity, since the predicted output trajectory will only need to be updated sporadically instead of at every bin of the sequence. Thus, in the context of predicting neuron output, the future estimate only requires updating—instead of recreating or recalculating the entire prediction—when a new event input comes in.

Assuming a basis function spans 1000 timebins, when provided with a current coefficient, the neuron may produce the subsequent 1000 timebin outputs simultaneously, rather than calculating them one by one. The network's output could be achieved by summing the output responses from all output neurons, yielding, in some embodiments, a singular scalar signal. The process does not necessitate an iterative, timebin-by-timebin approach. Instead, the forthcoming 1000 values may be effectively provided in one comprehensive process.

In some embodiments, if the incoming coefficient in the storage buffer for the next timebin is zero, then the output estimation remains unchanged. That is to say, the output that is to be generated includes the previous 999 values along with a single zero appended at the end. Further, in the event of a non-zero coefficient appearing in the subsequent timebin's as input in the storage buffer, this coefficient adds to the already computed 999 values and appends its own distinct value at the end, resulting in the collective establishment of the subsequent 1000 output values.

FIG. 13 illustrates an example scenario having a single coefficient C1 with a non-zero value in the storage buffer. Consider that the storage buffer 410 is configured to receive the new input 404, then the dot product will be performed between the coefficient C1 of the storage buffer 410 with the first basis value B1 of the basis function (i.e., basis 1). Accordingly, the output is given as C1*B1. Further, when the next new zero input comes in, the dot product due to the non-zero components is between C1 and B2 (i.e., the second basis function value). Thus, the output is given as C1*B1 in the first bin and C1*B2 in the second bin. Similarly, if there are N number of basis values, then the output is given as C1*B1, C1*B2, C1*B3, . . . , C1*BN across the N bins. Accordingly, the output signal is generated by simply multiplying the coefficient C1 with the complete basis 1 provided that the coefficient C1 is a non-zero value.

In some embodiments, the neural processor 320 is configured to receive a new input data sequence in the storage buffer. The neural processor 320 is further configured to determine whether the new input data event is a non-zero event. Based on the determination that the new input data event is the nonzero event, the neural processor 320 is configured to predict a future response of the neuron based on a result of the multiplication of the coefficient with the complete basis function.

FIG. 14 illustrates another example scenario having multiple non-zero coefficients, i.e., C1, C2, C3, . . . CN, in the storage buffer 410. Consider that the storage buffer 410 is configured to receive the new input 404, then the dot product will be performed between the coefficient C1 of the storage buffer 410 with the first basis value B1 of the basis function (i.e. basis 1). Accordingly, the output of the dot product is given as C1*B1 for the 1st bin. Further, when the next new input comes in, the dot product is between the vectors (C1,C2) and (B2,B1), (i.e., the second basis function value B2), which gives C1*B2+C2*B1 for the second bin. Thus, the output of the dot product is given by expression (a) for the first and second bins.

$$Output of the dot product = \{ C 1 * B 1 , C 1 * B 2 + C 2 * B 1 \} \qquad ( a )$$

In a similar manner, when a new third bin input comes in, the output of the dot product is given by equation (b) for the first 3 bins.

$$Output of the dot product = \{ C 1 * B 1 , C 1 * B 2 + C 2 * B 1 , C 1 * B 3 + C 2 * B 2 + C 3 * B 1 \} \qquad ( b )$$

To clarify, consider an event when a non-zero coefficient value appears in the storage buffer. In such a scenario this coefficient adds to the already computed values and appends its own distinct value at the end, resulting in the collective establishment of the subsequent output values. Further, the number of occurrences of such events (i.e., having a non-zero coefficient value) is considered as a number of delays in the contribution of the basis function in the generation of the output signal. Accordingly, the future response of the neurons is predicted based on equation (c), where DT is the bin size.

$$Prediction of the future response of the neurons = C 1 * Basis 1 + C 2 * Basis 1 ( delayed DT ) + C 3 * Basis 1 ( delayed 2 * DT ) + … + CN * Basis 1 ( delayed N * DT ) . \qquad ( c )$$

In some embodiments, the neural processor 320 is configured to receive a new input data sequence in the storage buffer. The neural processor 320 is further configured to determine whether the new input data event is a non-zero event or a zero event. Based on the determination that the new input data event is the non-zero event, the neural processor 320 is configured to add the coefficient to previously computed values and append a result of the multiplication at the end, resulting in the collective establishment of the output values. Further, the number of occurrences of such events (i.e., events having the non-zero coefficient value) enables the neural processor 320 to determine the number of non-zero coefficients as the number of delays in the contribution of the basis function in order to generate the output signal or the reconstructed signal. Accordingly, the neural processor 320 may be configured to predict the future response of the neurons based on a multiplication of the determined number of delays with the coefficient and the complete basis.

Thus, the output estimate only needs to be updated at every non-zero input coefficient (event) and the neuron output is immediately determined in the future for the whole duration of the basis function all at once. This provides a big advantage compared to traditional neural networks in which only one bin size output is given at a time. In some embodiments, an entire output of size N bins may be provided as the output as soon as a non-zero coefficient is an input to the output neuron. Thus, in some embodiments, a non-zero coefficient coming into the buffer at time t, defines immediately available at time t the future neuron output for the next N bins, thus up to time t+N*DT into the future. The neural network does not need to simulate the neural network outputs timestep by timestep, or bin by bin, to generate the future outputs. Rather, the best estimate for the next future N bins is readily available at once at the current time.

In some embodiments, the future estimate is updated at once as soon as a new non-zero coefficient value enters the buffer. Thus, the network output layer may provide immediately the future trajectory that the neural network output will follow for some time into the future. This is particularly useful for implementing any kind of planning, such as robot or autonomous vehicle trajectory planning.

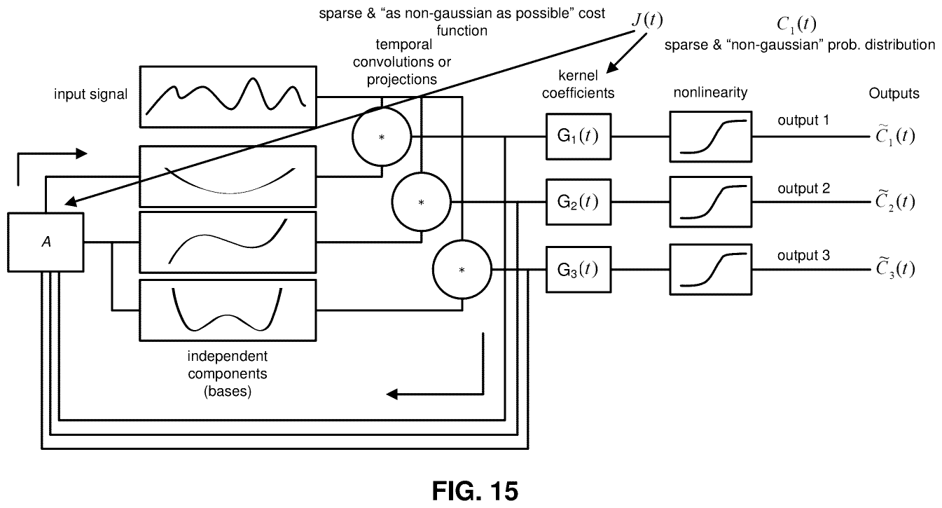

FIG. 15 illustrates a further example of operations that may be performed in neural network systems according to some embodiments. In such embodiments, the neural network system may apply a temporal convolution or projection to the input signal, generating coefficients. These coefficients may be iteratively refined using a sparse cost function, denoted as J(t), which enforces sparsity and statistical independence. This ensures that each coefficient activates selectively, capturing unique and distinct features of the input signal while driving the coefficients toward a probability distribution that is both sparse and as non-Gaussian as possible. This minimizes redundancy and enhances the fidelity of the representation, which is important for efficient data processing.

As described above, the cost function may include different terms, one of which may be the product, but this is not exclusive. In some embodiments, the cost function is used in training to adapt parameters. Alternatively, the cost function may be used to generate a feedback that can direct the network activity to improve to be closer to optimizing the cost function. The cost function may include costs to provide sparse activations, which may be factorial code, that may result in activations that are more independent from each other than before application of the cost function. The cost function may have different “terms,” one of which may be for encouraging sparsity. Other terms may be for reducing some output errors, which may be typically supervised. Other terms may be unsupervised for fulfilling different constraints.

The neural network system may operate within the context of event-driven architectures, such as Akida®-inspired neuromorphic processors, designed for real-time sensory data processing. By ensuring sparsity and independence, the neural network system reduces redundant computations, enabling faster, energy-efficient operation. This event-based efficiency is particularly beneficial in applications like real-time monitoring and sensory processing, where computational and power resources are constrained.

To enhance adaptability, the neural network system may employ Legendre polynomial expansions to express nonlinearity. This approach provides a flexible and precise representation as Legendre polynomials form an orthogonal set of functions that capture unique information without overlapping. By dynamically adjusting the nonlinearity to align with the probability distribution of the coefficients, the neural network system increases or maximizes entropy and achieves a uniform output probability distribution. This uniformity facilitates efficient quantization, enabling the full range of available bits in digital representations to be utilized, minimizing information loss, and improving precision.

The neural network system incorporates a hierarchical multiscale decomposition strategy, generating independent basis at various levels of abstraction akin to wavelet decomposition. For example, in vision processing, fine-scale basis functions may capture edges that define sharp transitions, while coarse-scale basis represent larger features such as wheels or vehicles. This hierarchical organization enables the progressive combination of features, such as edges forming wheels and wheels combining into vehicles, to efficiently represent complex objects across different scales.

Each basis may be refined through a recursive process involving state operator A, which applies operations such as scaling, matrix multiplication, and nonlinear transformations to dynamically adjust the basis functions. These transformations iteratively modify the basis functions to ensure they are sparse and statistically independent at each scale. This iterative process enhances the neural network system's adaptability to diverse input characteristics, supporting robust feature extraction.

The neural network system also allows for alternative methods to enforce sparsity and independence, including Independent Component Analysis (ICA) and Slow Feature Analysis (SFA). For instance, SFA identifies slowly varying features, such as isolating distinct voices in a cocktail party problem or separating speech from background noise in audio processing. These alternatives provide flexibility for applications where specific optimization goals or constraints are present.

The neural network processes of embodiments illustrated in FIG. 15 provide a multiscale, event-driven approach that is particularly advantageous for applications such as speech recognition, where basis functions may correspond to frequencies or phonemes, and image processing, where basis functions capture edges or other hierarchical features. By ensuring minimal redundancy and maximal entropy, such embodiments support high-efficiency data compression, transmission, and encoding.

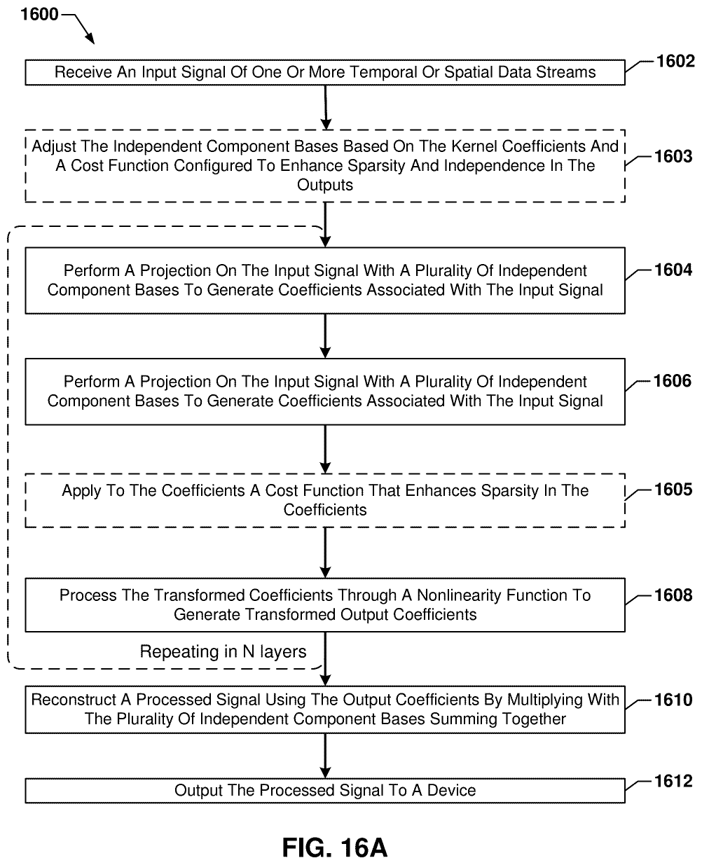

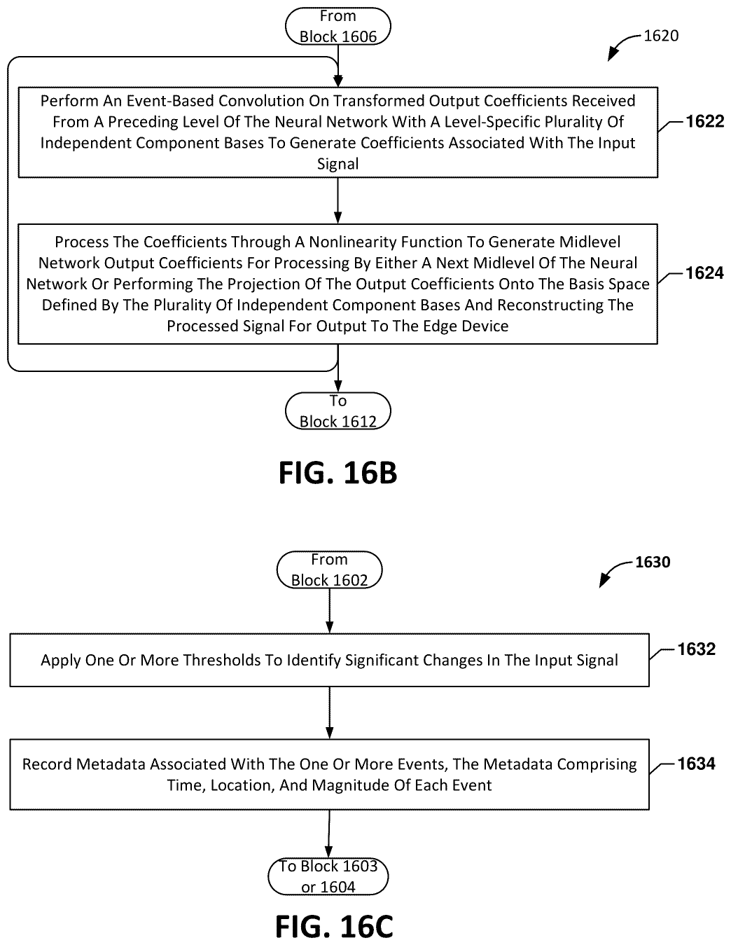

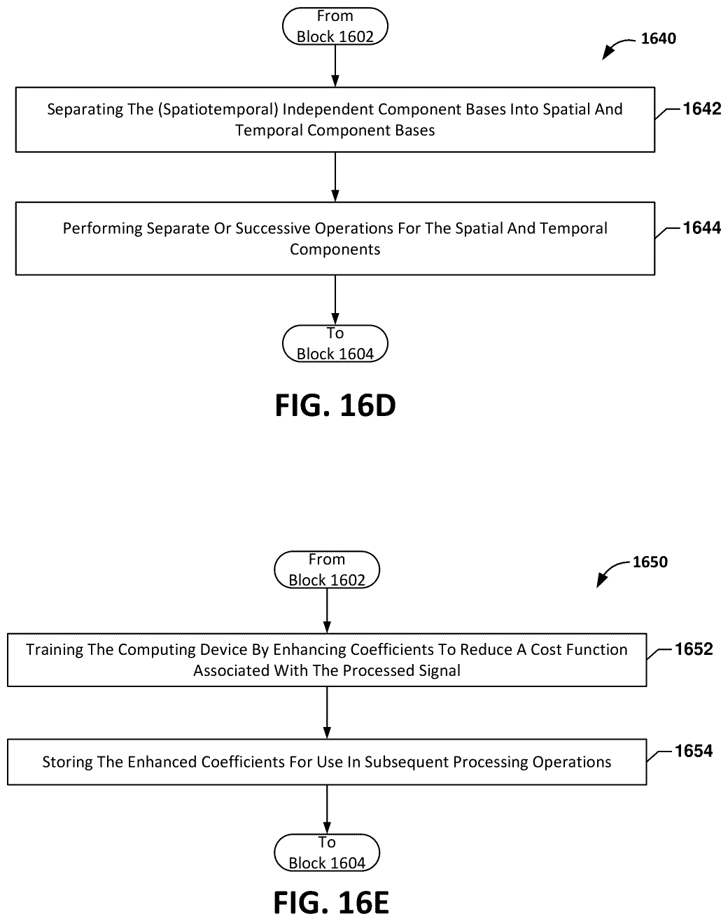

FIGS. 16A-16E are process flow diagrams illustrating operations of a computing device implemented method 1600 for processing spatiotemporal data in a neural network in accordance with some embodiments. In some embodiments, the method 1600 and the processing system executing the method may be configured to operate in one of a buffer mode or a recurrent mode, and dynamically switch between the buffer mode and the recurrent mode, such as based on input signal characteristics. The method 1600 illustrated in FIG. 16A, and operations 1620, 1630, 1640 and 1650 illustrated in FIGS. 16B-16E that may be performed as part of the method 1600, may be performed in a computing device by a processing system encompassing one or more processors (e.g., processors 120-132, etc.), neural processors, components, and/or subsystems discussed in this application. In some embodiments, the method 1600 and operations 1620, 1630, 1640, and 1650 may be performed by an event-based neural processing unit using hardware-accelerated event-based processing circuits of the event-based neural processing unit to improve computational efficiency. For ease of description, the component(s) that perform each set of operations is referred to in the following description as a “processing system,” which is intended to encompass any or all of the processing and memory components described herein that may be involved in performing such operations.

Referring to FIG. 16A, in block 1602, the processing system may perform operations including receiving an input signal including one or more temporal or spatial data streams.

In block 1604, the processing system may perform operations including performing a projection on the input signal with a plurality of independent component basis to generate coefficients associated with the input signal. In some embodiments, the operations in block 1604 may include skipping computations of zero-value data points in the input signal and focusing coefficient computations on non-zero-value data points and non-zero-values in the independent components basis.

In block 1606, the processing system may perform operations including performing multiplication of the coefficients with gain values to generate transformed coefficients.

In block 1608, the processing system may perform operations including processing the transformed coefficients through a nonlinearity function to generate transformed output coefficients. In some embodiments, the nonlinearity function may be configured to increase the entropy of the transformed coefficients output by adapting to a probability distribution of the input signal. In some embodiments, the nonlinearity function may include or be in the form of a polynomial expansion.

In a neural network system including multiple layers of neurons (e.g., N layers), the transformed output coefficients generated in block 1608 may be input into the next layer in the network. That level in the neural network then performs operations in blocks 1604 through 1608, before outputting transformed output coefficients to either the next layer or into a final layer that performs the operations in block 1608.

In block 1610, the processing system may perform operations including reconstructing a processed signal using the output coefficients by multiplying with the plurality of respective components of the independent component basis summing together. In some embodiments, the processing system may reconstruct the processed signal using the sparse coefficients by applying a cost function configured to penalize correlated coefficients and enhance sparsity of the reconstruction. In some embodiments, the operations performed in block 1610 by the processing system may include suppressing coefficients associated with noise components, and aggregating the remaining coefficients with the independent component basis to reconstruct the processed signal.

In block 1612, the processing system may perform operations including outputting the processed signal to a device. Non-limiting examples of processed signals that may be output to the device include voice enhancement in a hearing aid or microphone, image processing in a camera or imaging system, motion analysis in a security system, and/or autonomous vehicle control information or commands in an autonomous vehicle as described herein.

In some embodiments, in block 1603, the processing system may perform operations including adjusting the independent component basis based on the coefficients and a cost function configured to enhance sparsity and independence in the outputs. As described with reference to FIG. 15, increasing sparsity and independence in the independent component basis may improve the processing efficiency (e.g., reducing processing power), reduce latency, and improve the detection of edges and events. The adjustments to the independent component basis in block 1603 may be performed in either or both of the buffer mode and recurrent mode.

In some embodiments, in block 1605, the processing system may perform operations including applying to the coefficients a cost function (e.g., J(t) as illustrated in FIG. 15) that enhances sparsity and independence in the coefficients. In some embodiments, the operations in block 1605 may include adjusting the independent component basis by applying the cost function to generated coefficients generated by the (event-based) projection in block 1504. As described above, increasing sparsity and independency may reduce redundant computations, enhancing event-based efficiency, and enhance edge detect, event detection and trajectory identification. In some embodiments, the operations in block 1605 may be performed prior to processing the coefficients through a plurality of nonlinearity functions.

Referring to FIG. 16B, in some embodiments the processing system may repetitively perform operations 1620 in each midlevel of the neural network system to further process the input signal. In block 1622, the processing system may perform operations including performing an (event-based) projection on transformed output coefficients received from a preceding level of the neural network with a level-specific plurality of independent component basis to generate coefficients associated with one or more events in the input signal. In block 1624, the processing system may perform operations including processing the coefficients through a nonlinearity function to generate midlevel network output coefficients for processing by either a next midlevel of the neural network or performing the projection of the output coefficients onto the basis space defined by the plurality of independent component basis in block 1608 and reconstructing the processed signal for output to the edge device in block 1610.

Referring to FIG. 16C, in some embodiments the processing system may perform operations 1630 to detect one or more events in the input signal. In block 1632, the processing system may perform operations including applying one or more thresholds to identify significant changes in the input signal. In block 1634, the processing system may perform operations including recording metadata associated with the one or more identified events, the metadata including time, location, and/or magnitude of each event.

Referring to FIG. 16D, in some implementations the input signal may include spatiotemporal data. In such implementations and embodiments, the processing system may perform operations 1640 further including separating spatial and temporal components of the independent functions in block 1642 to form separable spatial and temporal component bases and performing separate or successive projection operations for the spatial and temporal components in block 1644.

Referring to FIG. 16E, in some embodiments the processing system may perform training operations 1650. In block 1652, the processing system may perform operations including training the computing device by enhancing coefficients to reduce a cost function associated with the processed signal. In block 1654, the processing system may perform operations including storing the enhanced coefficients for use in subsequent processing operations.

In some embodiments, the processing system may perform operations to retrain or fine-tune the model by generating the plurality of independent component basis recursively through a recurrent network based on the generated coefficients. In some embodiments, such operations may include generating the plurality of independent component basis dynamically at runtime using a state-space representation of the generated coefficients. In some embodiments, such operations may include retaining coordinates of the transformed output coefficients relative to the independent component basis, and generating sparse coefficients representing contributions of the transformed output coefficients to the independent component basis. In such embodiments, the operations of block 1608 performed by the processing system may include generating independent components by applying an independent component analysis (ICA) to the transformed coefficient output, and decorrelating the coefficients across higher statistical orders to create sparsity.

The various embodiments may be particularly useful in a number of edge device applications where rapid processing of spatial and/or temporal data streams are of value. A specific application example is specifying in advance the entire trajectory of an autonomous vehicle for say, the next 10 seconds. Another application example is to determine the entire trajectory of another vehicle on the road also, say, for the next 10 seconds. Yet, another application example is of an autonomous vehicle control system recognizing the potential of a collision in the next few seconds by comparing the trajectories of the self-driving vehicle and another other vehicle. If a collision has been predicted to occur, then a feedback is provided to the neural network, which may modify the generation of its coefficients through its neural activity to provide an updated future trajectory for the autonomous vehicle. This process may be quickly repeated until a trajectory deemed to be safe of potential future collisions is generated, which may then be implemented by the vehicle control system. Because of current limitations of neural networks, conventional autonomous vehicle systems are typically not used for safe trajectory determination. Various embodiments render such timely determinations possible.

Similar processing may be implemented in vision-based system that involve motion detection and predictions, such as augmented vision systems, military equipment, etc. In such applications, the ability to detect and rapidly project the trajectory of an object in a digital imaging system may enable rapid reactions that are not enabled by conventional image processing techniques. In a similar fashion, complete trajectory generation is of benefit in targeting system for military, or in order to reach a trajectory goal, such as for self-driving vehicles or robots in general. It eliminates the need to iterate time-step by time-step in order to verify whether the trajectory will reach the goal because the entire trajectory can be provided at once for an entire future period of time.

As another application example, some embodiments may be applied to sound processing, particularly speech enhancement as may be performed in hearing aids and some microphones. By processing sounds (e.g., phonemes) in a temporal data stream in such a neural network processing, modifications of coefficients through neural activity may adjust to certain sounds to enhance speech elements while deemphasizing background noises.

Even though the above presentation of the decoder layer describes processing the input data sequence in the time domain, some embodiments are not limited to the time domain. For example, the neural network processing remains the same as described above if the sequence is in the spatial domain. In such applications, the variables are spatial, such as pixel locations, that are processed instead of temporal. Moreover, the dimensions of the basis functions are not limited to the examples above, such as one dimensional tensors. The description of various embodiments herein is generalizable to basis functions in multiple dimensions with the appropriate dimension adjustments for all the tensors involved. For example, given a spatial sequence, such as the processing of pixels of a digital image, the decoder output trajectory could predict at once the two dimensional “trajectory” of the values over pixel space for the next, say 100×100 spatial bins, thereby completing an image.

Some embodiments may include a neural processor configured to apply non-linear activation functions to scalar multiplication output values, resulting in the generation of non-linear encoded output values. These non-linear transformations may allow the neural network to model complex relationships within the input data, enhancing the system's ability to process intricate temporal or spatial patterns. The technical effect(s) achieved by this approach includes improved data representation and a more accurate extraction of features, which may be particularly beneficial for applications involving sequential or high-dimensional data.

In some embodiments, the system processes temporal data sequences through multiple neural network layers in which each layer refines the representation of input data. Output data from one layer may be used as input for the next to allow progressive encoding of temporal dependencies. This hierarchical data processing method may provide at least the technical benefit of efficiently handling sequential data with high precision. Such an approach may be particularly advantageous for systems that use real-time analysis and decision-making because it helps ensure that data dependencies are preserved across layers while maintaining computational efficiency.

In some embodiments, the neural network may implement a pipelined processing approach. While one layer fetches data from the input interface, subsequent layers process the previously fetched data. This parallelized operation may reduce latency to allow the system to process data sequences in real-time without interrupting the flow of computation. The pipelining technique may contribute to the technical effect of minimizing processing delays, which may be important for time-sensitive applications such as autonomous systems and streaming data analysis.

In some embodiments, the decoder component of the system may reconstruct signals by applying coefficients to basis functions through a linear combination process. This reconstruction method may provide significant technical advantages by, for example, allowing the generation of signals with high fidelity and precision. Unlike conventional approaches that rely on single scalar weights, some embodiments may independently weigh each basis function with time-varying coefficients, which may allow for greater flexibility and accuracy in signal reconstruction. This may result in output signals that are more representative of the underlying data patterns, improving performance in applications such as signal processing and content generation.

Some embodiments may include methods for reducing the number of mathematical operations during signal reconstruction. For example, by applying threshold functions to coefficients, only the relevant basis functions contribute to the final output. This selective computation may reduce resource usage and accelerate processing to allow the system to operate effectively in constrained environments such as edge devices or embedded systems. The technical effect of this method is, for example, a reduction in computational overhead that leads to faster and more efficient data processing.

In some embodiments, the system may include the ability to predict future outputs based on sparse neuronal activity, which may introduce additional technical benefits. By leveraging precomputed coefficients and basis functions, the system may generate future outputs for extended durations without iterating through individual time steps. This capability may eliminate the need for repeated calculations, allowing for rapid trajectory predictions in applications such as autonomous navigation and motion planning. The system's predictive mechanism may provide real-time responsiveness while maintaining accuracy, which is important for systems requiring immediate feedback and adaptation.

In some embodiments, the architecture may include a hierarchical multiscale decomposition mechanism that allows the neural network to extract features at varying levels of abstraction. Fine-scale components may capture detailed features, such as edges, while coarse-scale components may represent broader structures, such as objects. This multiscale approach may enhance the system's ability to process complex data efficiently to provide a technical effect of, for example, improved feature extraction and hierarchical representation. This functionality may support applications ranging from image recognition to sensory data analysis.

In some embodiments, the system may use dynamic adjustment of basis functions using state operators to adapt to varying input characteristics. The system may provide uniform output distributions by, for example, leveraging orthogonal function expansions such as Legendre polynomials. This uniformity may facilitate efficient quantization and reduce information loss, which may provide the technical advantage of enhanced precision in digital representations. This adaptability makes the embodiments well-suited for diverse applications, including speech enhancement, real-time monitoring, and autonomous control systems.

In some embodiments, the system may further reduce redundancy and enhance efficiency through sparsity-driven mechanisms. Cost functions may be used to prove sparse activations, which may improve the system's ability to identify unique features while reducing computational load. The system may achieve higher fidelity in data processing by maintaining statistical independence among coefficients, which may support technical applications in which energy efficiency and rapid response are important. This architecture may be particularly advantageous for real-time sensory data processing and decision-making tasks in constrained environments.

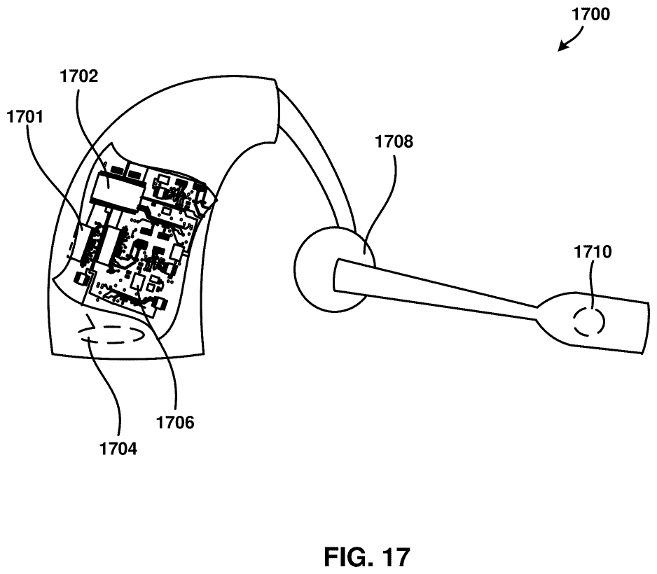

FIG. 17 is a component block diagram of an edge device 1700 suitable for use with various embodiments. With reference to FIGS. 1-17, various embodiments may be implemented on a variety of edge devices, an example of which is illustrated in FIG. 17 as a wearable computing device in the form of a headset 1700. A headset 1700 may include a processing system 1701 (e.g., one or more processors 101, 102, 320) coupled to memory 1702 (e.g., DDR4/DDR5 SDRAM, etc.), an antenna 1704, a wireless transceiver 1706, a speaker 1708, and a microphone 1710, any or all of which may be coupled to each other and/or to the processing system 1701. The memory 1702 may include standard-performance memory, high-performance memory, volatile memory, non-volatile memory, dynamic memory, static memory, or any combination thereof (e.g., static memory and standard-performance volatile memory, etc.).

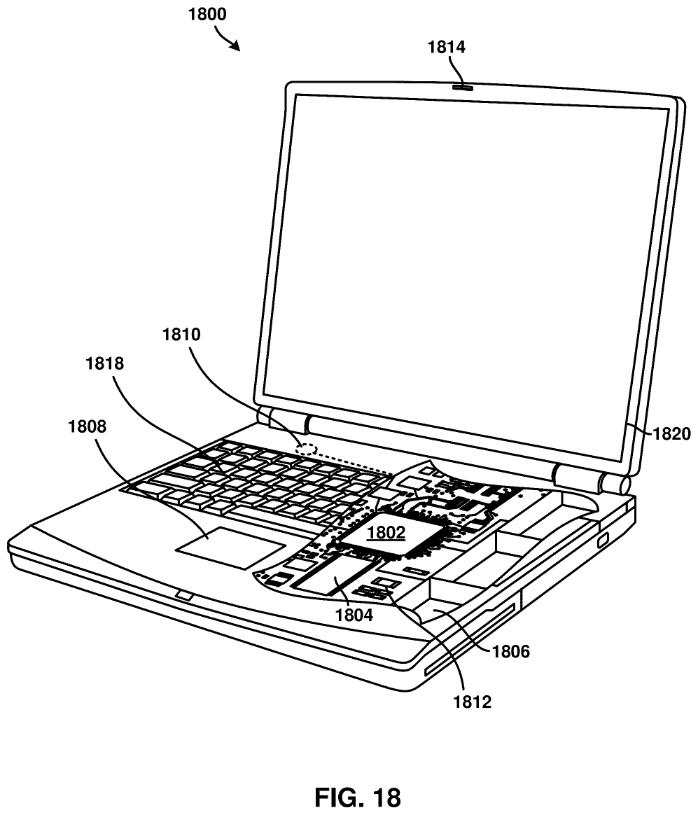

FIG. 18 is a component block diagram of an edge device 1800 suitable for use with various embodiments. With reference to FIGS. 1-18, various embodiments may be implemented on a variety of edge devices, an example of which is illustrated in FIG. 18 in the form of a laptop computer 1800. A laptop 1800 may include a processor 1802 (e.g., one or more processors 101, 102, 320) coupled to a memory 1804, which may include standard-performance memory, high-performance memory, volatile memory, non-volatile memory, dynamic memory, static memory, or any combination thereof. For example, memory 1804 may include dynamic random-access memory (DRAM) for volatile storage and non-volatile memory such as flash or solid-state storage, such as a Non-Volatile Memory Express (NVMe) solid-state drive (SSD) 806. The laptop 1800 may include multiple antennas 1810 designed to support various wireless communication standards, including Wi-Fi 6/6E, 5G cellular connectivity, and Bluetooth. These antennas are connected to a wireless data link and a cellular transceiver 1812, both of which are coupled to the processor 1802. In addition, the laptop 1800 may include a precision touchpad 1808 that supports multi-touch gestures and other modern input/output peripherals, such as a backlit keyboard 1818 and a high-resolution display 1820 (e.g., 4K OLED or Mini-LED). The laptop 1800 may also include a camera 1814 that may support biometric authentication via facial recognition performed by the processor 1802.

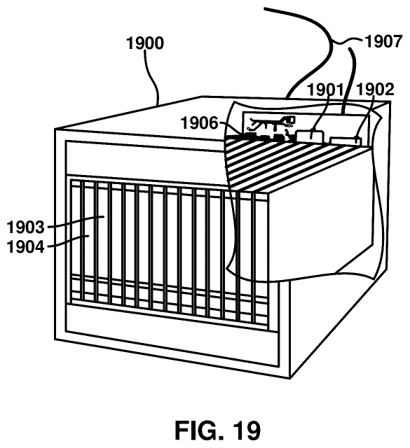

All or portions of some embodiments may be implemented in the cloud or on a variety of commercially available computing devices, such as the server computing device 1900 illustrated in FIG. 19. The server device 1900 may include one or more processors 1901 (e.g., multi-core processor, etc.) coupled to volatile memory 1902, such as RAM, and a large capacity nonvolatile memory, such as a solid-state drive (SSD) 1903. The server device 1900 may also include additional storage interfaces such as USB ports and NVMe slots coupled to the processor 1901. The server device 1900 may include network access ports 1906 coupled to the processor 1901 that allow data connections through a network interface card (NIC) 1904 and a communication network 1907 (e.g., an Internet Protocol (IP) network) connected to other network elements.

The methods, systems, and apparatus discussed above are merely for example purposes. Various configurations may omit, substitute, or add various procedures or components as appropriate. For instance, in alternative configurations, the methods may be performed in an order different from that described, and various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Various embodiments are described above with reference to block diagrams and/or operational illustrations of methods, systems, and computer program products according to embodiments of the present disclosure. The functions/acts noted in the blocks may occur in a different order than shown in any flowchart. For example, two blocks shown in succession may be executed substantially concurrently or sometimes executed in the reverse order, depending upon the functionality/acts involved. Additionally, or alternatively, not all of the blocks shown in any flowchart need to be performed and/or executed. For example, if a given flowchart has seven blocks containing functions/acts, it may be the case that only five of the seven blocks are performed and/or executed. In this example, any of five of the seven blocks may be performed and/or executed.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only and does not limit the scope, applicability, or configurations of the claims. Rather, the preceding description of the configurations will provide those skilled in the art with an enabling description for implementing described techniques and neural network systems. Various changes may be made in the function and arrangement of elements without departing from the scope of the disclosure or the claims.

Having been provided with the description and illustration of the present application, one skilled in the art may envision variations, modifications, and alternate embodiments falling within the general inventive concept discussed in this application that does not depart from the scope of the following claims.

1. A neural network system, comprising:
an input interface configured to receive sequential data that includes input data sequences;
a memory configured to store a plurality of group of first basis function values, a first plurality of storage buffers corresponding to a current neural network layer, and implement a neural network that includes a first plurality of neurons for the current neural network layer, a corresponding group among the plurality of groups of the first basis function values is associated with each connection of a corresponding neuron of the first plurality of neurons;
a processor, to perform a projection operation, configured to:
allocate the first plurality of storage buffers to a first group of neurons among the first plurality of neurons;
receive, from corresponding input data sequences over a first sequence window, a first input data sequence of the corresponding input data sequences into the first plurality of storage buffers allocated to the first group of neurons;
project the first input data sequence on a corresponding basis function values among the corresponding group of the first basis function values by performing, for each connection of a corresponding neuron of the first group of neurons, a first dot product of the first input data sequence of the corresponding input data sequences within a corresponding storage buffer of first plurality of storage buffers with the corresponding basis function values, wherein the corresponding basis function values is associated with a corresponding connection of the corresponding neuron of the first group of neurons;
determine a corresponding potential value for the corresponding neurons of the first group of neurons based on the performed first dot product; and
generate a plurality of encoded output responses based on the determined corresponding potential values.

2. The neural network system of claim 1, wherein
the memory is further configured to store a plurality of groups of second basis function values for a next neural network layer and a second plurality of storage buffers corresponding to the next neural network layer; and
the neural network includes a second plurality of neurons for the next neural network layer, the processor is further configured to:
allocate the second plurality of storage buffers to a group of neurons among the second plurality of neurons;
receive, from corresponding input data sequences over a second time window, a second input data sequence of the corresponding input data sequences into the second plurality of storage buffers allocated to the group of neurons into the second plurality of storage buffers; and
perform, for each connection of a corresponding neuron of the group of neurons among the second plurality of neurons, a second dot product of the second input data sequence of the corresponding input data sequences within a corresponding storage buffer of the second plurality of storage buffers with a corresponding basis function value among the corresponding group of the second basis function values.

3. The neural network system of claim 1, wherein the processor is further configured to:
determine, based on the performed second dot product, a corresponding potential value for the corresponding neurons of the group of neurons among the second plurality of neurons; and generate a second plurality of encoded output responses based on the determined
corresponding potential values associated with the corresponding neurons of the group of neurons among the second plurality of neurons.

4. The neural network system of claim 1, wherein, to determine the output response, the processor is configured to:
perform multiplication of the first dot product with a gain value to generate an intermediate output;
apply one or more nonlinear activation functions on the intermediate output; and
determine, based on the intermediate output, the corresponding output response for the corresponding neurons of the group of neurons among the first plurality of neurons.

5. The neural network system of claim 1, wherein, to determine the output response, the processor is configured to:
perform multiplication of the first dot product with a gain value to generate an intermediate output,
apply a cost function to the product wherein the cost function is configured to ensure sparsity in the intermediate output;
apply one or more nonlinear activation functions on the intermediate output; and
determine, based on the intermediate output, the corresponding output response for the corresponding neurons of the group of neurons among the first plurality of neurons.

6. The neural network system of claim 1, wherein one or more nonlinear activation functions are represented as a weighted sum over one or more basis functions with one of one or more adaptive coefficients or a pre-defined activation function.

7. The neural network system of claim 1, wherein the processor is further configured to perform each of the first dot product at the current neural network layer and the second dot product at the next neural network layer, simultaneously in parallel with respect to each other.

8. The neural network system of claim 1, wherein each basis function value among the plurality of group of first basis function values corresponds to a flipped value of kernel that is used in a case the processor is configured to perform a convolution operation instead of a projection operation.

9. The neural network system of claim 1, wherein a basis function value associated with each connection of a corresponding neuron is different with respect to the plurality of input data sequences received corresponding to the connection of the corresponding neuron.

10. A neural network system, comprising:
an input interface configured to receive sequential data that includes temporal data sequences; a memory configured to implement a neural network and store a plurality of gain values, a first reference tensor to update a memory tensor, wherein the neural network is configured to perform a temporal projection using one or more temporal layers, a corresponding temporal layer of the one or more temporal layers includes of a plurality of neurons;
for corresponding temporal layer of the one or more temporal layers, at least one processor configured to:
receive a first temporal data sequence of the temporal data sequences at a first time instance;
generate a projected temporal input based on a projection of the first reference tensor on the first temporal data sequence;
transform, for the first temporal data sequence, the memory tensor based on a matrix multiplication of a second reference tensor with the memory tensor;
generate an updated memory tensor based on the transformed memory tensor and the projected temporal input;
perform, for each connection associated with a corresponding neuron of a group of neurons among the plurality of neurons, a first element wise multiplication of the updated memory tensor with the plurality of gain values;
determine a corresponding potential value for the corresponding neurons based on the performed first element wise multiplication; and
generate a plurality of encoded output responses based on the determined corresponding potential values.

11. The neural network system of claim 10, wherein the at least one processor is further configured to:
receive a second temporal data sequence of the temporal data sequences at a second time instance;
transform the updated memory tensor based on a matrix multiplication of the reference tensor with the updated memory tensor, repetitively;
generate a new memory tensor based on an addition of the transformed updated memory tensor with the projected temporal input; and
perform, for the corresponding neuron of the group of neurons, a second element wise multiplication of the newly generated memory tensor with the plurality of gain values.

12. The neural network system of claim 10, wherein the at least one processor is further configured to transform the newly generated memory tensor at a consecutive time instance at which a new temporal data sequence of the temporal data sequences is received.

13. The neural network system of claim 10, wherein the at least one processor is further configured to repeatedly generate the new memory tensor until the updated memory tensor is transformed for each of the temporal data sequences.

14. The neural network system of claim 10, wherein, to determine the corresponding potential value for the corresponding neurons, the at least one processor is further configured to:
apply one or more activation functions on the corresponding result of the first element wise multiplication; and
determine the corresponding potential value for the corresponding neurons based on a result of the application of the one or more activation functions on the corresponding result of the first element wise multiplication.

15. The neural network system of claim 10, wherein the at least one processor is further configured to generate the updated memory tensor based on the transformed memory tensor, the projected temporal input, and a cost function, wherein the cost function is configured to enhance sparsity in the updated memory tensor.

16. The neural network system of claim 10, wherein the at least one processor is further configured to determine the corresponding potential value for the corresponding neurons based on the performed first element wise multiplication and application of a cost function, wherein the cost function is configured to enhance sparsity in the corresponding potential values for the corresponding neurons.

17. A computer-implemented method for performing spatiotemporal data processing in a neural network, the method comprising:
receiving, in a computing device, an input signal comprising one or more temporal, spatial or spatiotemporal data streams;
performing a projection on the input signal with a plurality of independent component basis to generate coefficients associated with the input signal;
performing multiplication of the coefficients with gain values to generate transformed coefficients;
processing the transformed coefficients through a nonlinearity function to generate transformed output coefficients;
reconstructing a processed signal using the output coefficients by multiplying with the plurality of respective components of the independent component basis summing together; and
outputting the processed signal to a device.

18. The method of claim 17, further comprising applying to the coefficients a cost function that enhances sparsity in the coefficients prior to processing the coefficients through a plurality of nonlinearity functions.

19. The method of claim 17, further comprising adjusting the independent component basis in a recurrent mode based on the coefficients and a cost function configured to enhance sparsity in the independent component basis.

20. The method of claim 17, wherein performing a (event-based) projection on the input signal with a plurality of independent component basis comprises:
skipping computations of zero-value data points in the input signal; and
focusing coefficient computations on non-zero-value data points and non-zero-values in the independent components basis.

21. The method of claim 17, wherein processing the coefficients through the nonlinearity function to generate the transformed coefficients output comprises processing the coefficients through a nonlinearity function configured to increase entropy of the transformed coefficients output by adapting to a probability distribution of the input signal.

22. The method of claim 21, wherein the nonlinearity function comprises a nonlinear polynomial expansion.

23. The method of claim 17, further comprising repetitively performing the following operations in each midlevel of the neural network:
performing a (event-based) projection on transformed output coefficients received from a preceding level of the neural network with a level-specific plurality of independent component basis to generate coefficients associated with one or more events in the input signal;
processing the coefficients through a nonlinearity function to generate midlevel network output coefficients for processing by either a next midlevel of the neural network or performing the projection of the output coefficients onto the basis space defined by the plurality of independent component basis and reconstructing the processed signal for output to the edge device.

24. The method of claim 17, further comprising detecting one or more events in the input signal by:
applying one or more thresholds to identify significant changes in the input signal; and
recording metadata associated with the one or more events, the metadata comprising time, location, and magnitude of each event.

25. The method of claim 24, wherein detecting the one or more events further comprises performing event-based sampling operations that generate time-stamped data points corresponding to intensity changes in the input signal.

26. The method of claim 17, further comprising generating the plurality of independent component basis recursively through a recurrent network based on the generated coefficients.

27. The method of claim 26, wherein generating the plurality of independent component basis recursively through a recurrent network based on the generated coefficients comprises generating the plurality of independent component basis dynamically at runtime using a state-space representation of the generated components.

28. The method of claim 26, wherein generating the plurality of independent component basis recursively through a recurrent network based on the generated coefficients comprises:
retaining coordinates of the transformed output coefficients relative to the independent component basis; and
generating sparse coefficients representing contributions of the transformed output coefficients to the independent component basis.

29. The method of claim 28, wherein performing a projection of the transformed output coefficients onto a basis space defined by the plurality of independent component basis comprises:
generating independent components by applying an independent component analysis (ICA) to the transformed component output; and
decorrelating the components across higher statistical orders to create sparsity.

30. The method of claim 28, wherein generating the sparse coefficients representing contributions of the transformed output to the polynomial basis further comprises using the sparse coefficients to train a neural network by enhancing parameters associated with event-driven processing layers.

31. The method of claim 17, wherein reconstructing a processed signal using the outputs of the projection of the output coefficients on the plurality of independent component basis comprises:
suppressing coefficients associated with noise components; and
aggregating remaining coefficients with the independent component basis to reconstruct the processed signal.

32. The method of claim 17, wherein reconstructing the processed signal using the sparse coefficients further comprises applying a cost function configured to penalize correlated coefficients and enhance sparsity of the reconstruction.

33. The method of claim 17, wherein:
the input signal comprises spatiotemporal data; and
the method further comprises:
separating spatial and temporal components of the basis into independent functions; and
performing separate projection operations for the spatial and temporal components.

34. The method of claim 17, wherein outputting the processed signal to the one or more downstream systems comprises outputting a processed signal output configured for use in at least one or more of:
voice enhancement;
image processing;
motion analysis; or
autonomous vehicle control.

35. The method of claim 17, further comprising:
training the computing device by enhancing coefficients to reduce a cost function associated with the processed signal; and
storing the enhanced coefficients for use in subsequent processing operations.

36. The method of claim 17, wherein:
the computing device is configured to operate in one of a buffer mode or a recurrent mode; and
the method further comprises dynamically switching between the buffer mode and the recurrent mode based on input signal characteristics.

37. The method of claim 17, wherein:
the method is performed by an event-based neural processing unit; and
the method further comprises using hardware-accelerated event-based processing circuits of the event-based neural processing unit to improve computational efficiency.
